(19) United States
(12) Patent Application Publication
(10) Pub. No.: US 2015/0312520 A1
(43) Pub. Date: Oct. 29, 2015

(54) TELEPRESENCE APPARATUS AND METHOD ENABLING A CASE-STUDY APPROACH TO LECTURING AND TEACHING

(71) Applicant: President and Fellows of Harvard College, Cambridge, MA (US)

(72) Inventors: Nitin NOHRIA, Boston, MA (US); Youngme MOON, Brookline, MA (US)

(21) Appl. No.: 14/693,294

(22) Filed: Apr. 22, 2015

Related U.S. Application Data
(60) Provisional application No. 62/029,101, filed on Jul. 25, 2014.
(60) Provisional application No. 62/004,114, filed on May 28, 2014.
(60) Provisional application No. 61/983,066, filed on Apr. 23, 2014.

(51) Int. Cl. H04N 7/15; G09B 7/02

(52) U.S. Cl. CPC H04N 7/15; G09B 7/02

(57) ABSTRACT

A telepresence method and system for mimicking a physical amphitheater classroom for a case-study course with remote students comprising a student wall shaped and arranged to define an amphitheater in an arc, an interior of the arc defining a teaching pit, the student wall including: a video display apparatus to present an array of images arranged in groups, a plurality of student speakers, and a plurality of student perspective cameras, each of the plurality of student perspective cameras associated with and located near a corresponding student image for capturing a unique perspective view of the telepresence classroom, wherein the dimensions of the student wall and of the images in relation to the teaching pit have a geometric relationship such that from the instructor's perspective the student images are approximately life-sized and the instructor can move anywhere within the pit and maintain a line of sight with the perspective student cameras.

### CROSS-REFERENCE TO RELATED APPLICATIONS

This application claims priority to U.S. Patent Application No. 61/983,066, filed Apr. 23, 2014, U.S. Patent Application No. 62/004,114, filed May 28, 2014, and U.S. Patent Application No. 62/029,101, filed Jul. 25, 2014, the entire contents of which are incorporated herein by reference.

### TECHNICAL FIELD

This disclosure relates generally to telepresence and distance learning and more specifically to an apparatus and method for a telepresence environment to enable a case study approach to real time distance lecturing and teaching which facilitates a high degree of interaction among students and the instructor.

### BACKGROUND

There are two types of teaching models generally employed in classrooms. The first is a lecture model, which usually includes an instructor at a lectern with a blackboard lecturing to a large group (e.g., an undergraduate class at a university). The lecture model is a passive form of learning. The main goal of a lecture-based approach to teaching is to distribute knowledge.

A second type of teaching model is the case study approach. The case study approach generally involves fewer students. The case study approach, generally used in business or law schools, focuses on student engagement and active learning. One of the goals of the case study approach is to involve students more actively in the learning process. In the case study approach, students are incentivized to stay alert by cold calls, prompted to debate among themselves in front of others, and encouraged to engage in critical thinking and intuition building exercises.

Traditional distance learning methods have generally employed the lecture model. Usually one instructor addresses a small group of students (e.g., no more than 10) using a static pre-configured system (e.g., Adobe Connect, Google Hangouts). The video quality is typically very low and the platform has limited flexibility for configuration. Additionally these platforms require an instructor to operate the controls and there is no option for multiple camera views of the instructor.

Another example of lecture based distance learning comes in the form of classroom to classroom teaching. These platforms require the students to go to a classroom location in order to attend the class and typically do not involve any type of web platform. In this example, the student has limited tools to remain engaged during the class. Students who are sitting in a remote classroom can passively watch the class with lower risk of being called on. These students also have limited ability to comment on what other students are saying. From an instructor's perspective, it becomes very difficult to understand whether students are engaged because remote classroom cameras are typically set to a wide shot of all students making it difficult for an instructor to read body language.

### SUMMARY

Preferred embodiments of the invention include a telepresence system and method for mimicking a physical amphitheater classroom for a case-study course with remote students. In some aspects of the invention, the system comprises a student wall approximately 9 to 15 feet in height shaped and arranged to define an amphitheater in an arc of about 90 to 210 degrees with a diameter generally between 27 to 32 feet in diameter, an interior of the arc defining a teaching pit where the instructor can move within. In some aspects, the student wall includes a video display apparatus to present an array of images arranged in groups, mimicking seating assignments in an amphitheater, the images generally rectangular with one side approximately 2 feet long and another side approximately 2.5 feet long, wherein each image is associated to a corresponding student participating in the course and the images are generally in a fixed seating arrangement during the course; a plurality of student speakers, each of the plurality of student speakers associated with and positioned near a corresponding student image, the plurality of student speakers outputting sound received from a corresponding live microphone such that any and all sound made by each student will be output as a point source of audio such that the instructor can associate and distinguish a sound with a student image from a position from which the sound originates; and a plurality of student perspective cameras, each of the plurality of student perspective cameras associated with and located near a corresponding student image for capturing a unique perspective view of the telepresence classroom for each student based on the location of a student image on the student wall, a portion of the student perspective cameras oriented such that each camera's field of view captures at least a portion of the student wall and the other student images, wherein the dimensions of the student wall and of the images in relation to the teaching pit have a geometric relationship such that from the instructor's perspective the student images are approximately life-sized and the instructor can move anywhere within the pit and maintain a line of sight with the perspective student cameras, mimicking a physical amphitheater classroom for a case-study course with remote students.

In some embodiments, the video display apparatus includes a computer controlled single screen, in which computer controls segment the screen into a plurality of student images. In some embodiments, the video display apparatus further presents at least one multimedia display area for displaying at least one of annotations made by an instructor on an electronic blackboard during class, a presentation, poll results, and student chats. In some embodiments, the multimedia display area comprises a ticker displaying student chats in real time. In some embodiments, the multimedia display area comprises at least one divider positioned between the array of images such that the array of images are divided into smaller groups of images. In some embodiments, a longer side of the image corresponds to a height of the image and a shorter side of the image corresponds to a width of the image.

Preferred embodiments of the invention include a telepresence system and method for mimicking a student experience in a physical amphitheater classroom for a case-study course with remote students. In some embodiments, the system comprises a student wall shaped and arranged to define an amphitheater in an arc, an interior of the arc defining a teaching pit where the instructor can move within, the student wall including: a video display apparatus to present an array of images arranged in groups, mimicking seating assignments in an amphitheater, wherein each image is associated to a corresponding student participating in the course and the images are generally in a fixed seating arrangement during the course; and a plurality of student perspective cameras, each of the plurality of student perspective cameras associated with and located near a corresponding student image for capturing a unique studio signal perspective view of the telepresence classroom for each student based on the location of the student image on the student wall, a portion of the student perspective cameras oriented such that its field of view captures at least a portion of the student wall and the other student images, the dimensions of the wall and of the images in relation to the teaching pit have a geometric relationship such that the instructor can move anywhere within the pit and maintain a line of sight with the perspective student cameras; at least one drama camera, the at least one drama camera configured to have a field of view of the teaching pit separate from the perspective views; a receiver configured to receive a plurality of course-related multimedia including: a plurality of unique studio signal perspective views, each of the plurality of unique studio signal perspective views corresponding to a field of view captured by a student perspective camera associated with and located near a corresponding student image, a plurality of remote location student video signals, each of the remote location student video signals corresponding to a video signal received from a live camera associated with and located near a remote student location, a plurality of remote location student audio signals, each of the remote location student audio signals corresponding to an audio signal received from a live microphone associated with and located near a remote student location, an instructor audio signal, the instructor audio signal received from an instructor microphone, and at least one drama camera video signal, the at least one drama camera video signal corresponding to the field of view captured by the at least one drama camera; and a dynamically controlled router for forming and transmitting a plurality of audio and video signals to the plurality of remote student locations, wherein each audio signal transmitted to each remote student location includes a unique student aggregate audio signal formed by aggregating an instructor audio signal and all remote location student audio signals minus the remote location student audio signal corresponding to the student where the unique student aggregate audio signal is transmitted to reflect the sounds of the classroom, and wherein the plurality of video signals are dynamically selected point-to-point video signals such that each student may have a unique video presentation including a unique studio signal perspective view, the unique studio signal perspective view corresponding to a field of view captured by a student perspective camera associated with and located near a corresponding student image, mimicking a student experience in a physical amphitheater classroom for a case-study course with remote students.

In some embodiments, the dynamically controlled router responds to operator control commands by a control room operator who monitors events in the course and selects a subset of video feeds to form the point-to-point video presentation to send to each student. In some embodiments, the course-related multimedia further includes multimedia answers responsive to an instructor query or question received from one or more students. In some embodiments, the course-related multimedia further include annotations made during the course by the instructor on an electronic blackboard. In some embodiments, the dynamically selected point-to-point video signals include a plurality of remote location student video signals enabling a debate mode such that students can focus on a discussion between a small group of students and the instructor. In some embodiments, the dynamically selected point-to-point video signals include at least one drama camera signal, the drama camera signal including at least one of a close up view of the teacher, a view of the entire teaching wall, and an overhead view of the classroom. In some embodiments, the video display apparatus includes a computer controlled single screen, in which computer controls segment the screen into a plurality of student images. In some embodiments, the video display apparatus includes a computer controlled single screen, in which the computer controls segments the screen into a plurality of student images. In some embodiments, the video display apparatus further presents at least one multimedia display area for displaying at least one of annotations made by an instructor on an electronic blackboard during class, a presentation, poll results, and student chats. In some embodiments, the multimedia display area comprises a ticker displaying student chats in real time. In some embodiments, the multimedia display area comprises at least one divider positioned between the array of images such that the array of images are divided into smaller groups of images. In some embodiments, each unique studio signal perspective view is adjustable and the receiver is further configured to receive student perspective view controls from each student corresponding to a pan and tilt of each student perspective camera with respect to a starting position.

### BRIEF DESCRIPTION OF DRAWINGS

FIG. 1 is an overhead perspective view of a case-study approach telepresence classroom, according to some embodiments of the present invention.

FIG. 2 is a two dimensional illustration depicting a student wall, according to some embodiments of the present invention.

FIG. 3 is a layout depicting landscape and portrait views of student images, according to some embodiments of the present invention.

FIG. 4A is a screenshot depicting a boards view on a control desk, according to some embodiments of the present invention.

FIG. 4B is a screenshot depicting a polls view on the control desk, according to some embodiments of the present invention.

FIG. 5A is a plan depicting a student video wall and a teaching stage, according to some embodiments of the present invention.

FIG. 5B is an illustration depicting an instructor and a student wall, according to some embodiments of the present invention.

FIG. 6 is a side view of the classroom, according to some embodiments of the present invention.

FIG. 7 is a perspective view of the teaching wall, according to some embodiments of the present invention.

FIG. 8 is a conceptual diagram of the case-study approach telepresence platform, according to some embodiments of the present invention.

FIG. 9A is a screenshot of a student computer platform including a student perspective view, according to some embodiments of the present invention.

FIG. 9B is a screenshot of a user platform, which includes both a perspective view and a drama camera view, according to some embodiments of the present invention.

FIG. 10A is a screenshot of a student's computer including a raise your hand feature, according to some embodiments of the present invention.

FIG. 10B is a perspective view of the classroom depicting a raise your hand indicator, according to some embodiments of the present invention.

FIG. 11A is a screenshot of a student's computer depicting debate mode with a student perspective view in the main window, according to some embodiments of the present invention.

FIG. 11B is a screenshot of a student's computer depicting debate mode with a student perspective view as one of four tiles, according to some embodiments of the present invention.

FIG. 12 is a screenshot depicting the blackboards feature, according to some embodiments of the present invention.

FIG. 13 is a screenshot of a student's computer depicting a polls feature, according to some embodiments of the present invention.

FIG. 14A is a screenshot of a student's computer depicting a chat feature, according to some embodiments of the present invention.

FIG. 14B is a perspective view of the classroom depicting a ticker, according to some embodiments of the present invention.

FIG. 15A is a screenshot of a student's computer depicting a right panel seating chart, according to some embodiments of the present invention.

FIG. 15B is a screenshot of a student's computer depicting a middle panel seating chart, according to some embodiments of the present invention.

FIG. 15C is a screenshot of a student's computer depicting a left panel seating chart, according to some embodiments of the present invention.

FIG. 16 is a system architecture diagram depicting a case-study approach telepresence system, according to some embodiments of the present invention.

### DETAILED DESCRIPTION

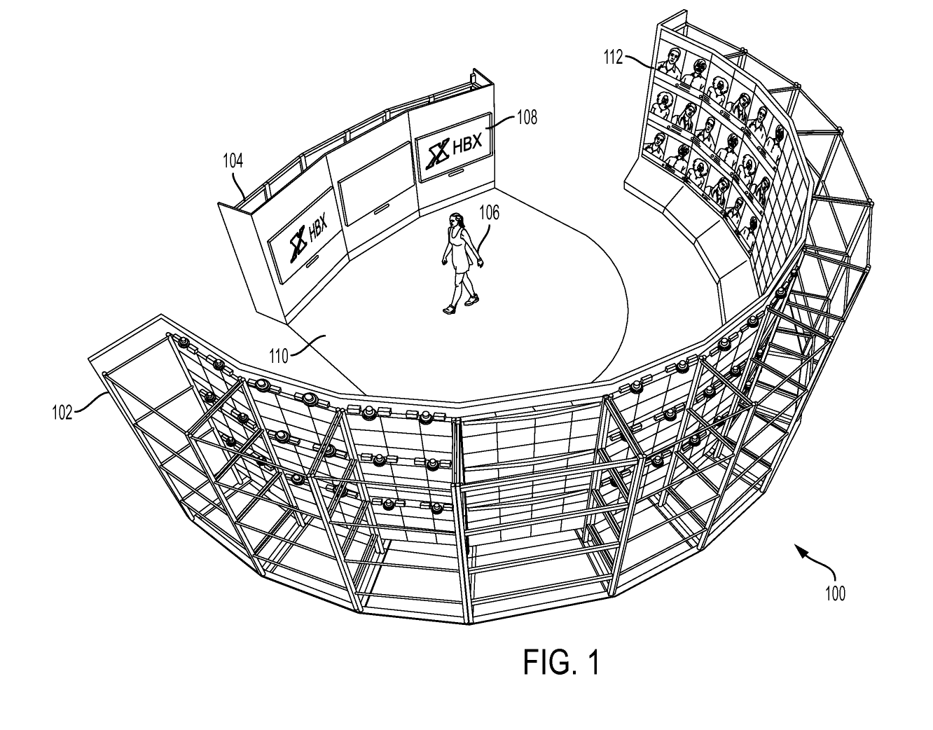

Preferred embodiments of the invention enable an instructor to conduct a class featuring a highly engaging, highly interactive, unscripted and spontaneous case-study style of learning. A maximally kinetic telepresence environment is created for the instructor which allows for live action at scale. A class of approximately 30-100 students are presented to the instructor in roughly life-size scale and arranged as the instructor would expect in a physical classroom. For example, a tiered arrangement of students can be arranged along an arc of roughly 180 degrees with a teaching stage at the center (See FIG. 1, described in more detail below). In some embodiments, the classroom is shaped like an amphitheater, which allows for intimacy at scale, reducing the distance from the instructor to each of the students and allowing the instructor to interact meaningfully with each student. All video and audio feeds are live so that the instructor would see and hear everything as he or she would in a physical class. As used herein, video feed can refer to video signals and audio feed can refer to audio signals. Lag time is minimized such that student vocalizations are projected almost immediately to the instructor. The arrangement of the video feeds on a video wall is physically configured and scaled to emulate a physical class context, and students are locked into their seats for the duration of a class. This encourages the instructor to move about the classroom and interact with students just as he or she would in the classroom creating an engaging presentation and not like the classic model of talking to a camera or some remote third person perspective. Likewise, this facilitates an environment for the student in which the instructor at points will be lecturing to the group and other times directly interacting with a specific student, e.g., cold call, or selected small group of students to initiate a group discussion or debate for the rest of the students to witness. A variety of controls and tools are provided for the instructor and the students to enable the interactions between student and instructor, and interactions among students themselves. In this fashion, an environment is created which emulates a case-study lecture room, and which facilitates and actively encourages that style of learning.

Preferred embodiments of the invention create a real lecture hall feel for the students. Students, from individual computing devices, feel like they are sitting in the lecture hall with the instructor. Through individual cameras that offer perspective views, each student has a unique view of the class as if they occupied a seat in the lecture hall. Perspective views allow students to engage in the class through an instructor's body language or movements. For example, if an instructor walks up next to a student, the student can feel a heightened sense of anticipation of being called on by the instructor. In some embodiments, students are arranged on a video wall in rows and tiers, as in a real lecture hall. A student sitting on the right side of the wall would have a view as if they sat on the right side of the room in a lecture hall, while a student sitting on the left side of the wall would have a view as if they sat on the left side of the room. In some embodiments, a portion of the perspective views capture at least a portion of the wall and of other students. The perspective views can be fixed or can be adjusted by a student. For example, a student can maneuver his or her perspective view with approximately 150 degrees of freedom to the left and right (e.g., pan) from a starting position. A student can also maneuver his or her perspective view with approximately 90 degrees of freedom up and down (e.g., tilt) from the starting position. In some embodiments, the starting position for a perspective view corresponding to an adjustable camera is the same as a position of a fixed camera. The perspective view can also include a zoom feature allowing a student to change the magnification of his or her perspective view (e.g., up to approximately a 20× zoom in or approximately a 20× zoom out).

Students are also shown multiple video feeds. A production team utilizes several cameras to hone in on exciting or dramatic moments of a lecture. The video feeds are processed in real time in a control room and can be used to supplement a student's perspective view.

Students are also shown their own video feed. Keeping a student's own image on their screen keeps them aware of how they look in class and promotes keeping them looking engaged.

Students also have ability to interact with other students and instructors as they would in a real classroom. Students can chat with other students, submit questions, answer polls, or raise their hand. Through a microphone attached to their computing device, students can ask the instructor a question or have a dialogue with fellow students.

Preferred embodiments of the invention create a real lecture hall feel for instructors lecturing in a case-study approach telepresence classroom. As described above, student image profiles are sized on a student video wall proportionally to a student's actual size as if they were physically present in a seat corresponding to their location on the video wall. The instructor can hear all of the students at all times during the lecture. In some embodiments, all of the student's microphones remain hot during the lecture. Whether it is an answer to a question, rustling of paper, a sigh, or laughter, the instructor can hear student activity as if the students were physically present in the room.

An instructor can get immediate feedback about student engagement. Each student has a real time video and audio feed throughout the entirety of the lecture. The instructor can see if a student is growing restless or looking confused. The instructor can see facial expressions and hand gestures. The instructor can immediately respond to a comment, a smirk or laughter. In addition to a personalized image on the video wall, students also have individual speakers. During a discussion, the instructor can tell immediately which student makes a comment. For example, the instructor can tell whether a student in the top row, left side of the wall makes a comment or whether a student in the middle row, right side makes a comment.

Instructors also have tools in the virtual classroom as they would have in a regular lecture hall. Instructors have a stage to walk around in the virtual classroom. The stage allows the instructor to walk up to students, to speak with movements and gestures, and to have the freedom to move generally as they would in a lecture hall. The stage is designed such that every student has a view of the instructor regardless of where the instructor is located on the stage. In some embodiments, a stage is not used, and the student wall defines an area (e.g., a pit) where an instructor can move around and maintain visual contact with the students.

Instructors preferably use digital blackboards to make annotations during a lecture. Annotations made on the blackboard can be displayed various places within the classroom such that a instructor, facing any direction in the classroom, has access to the annotations. The contents of the blackboards can also be accessed and enlarged by students via computing devices.

Preferred embodiments of the invention create a telepresence environment for all of the students participating in the virtual classroom. The system described herein can support up to approximately 100 students in one classroom session. By leveraging standard classroom etiquette, students, without purchasing or using special equipment, can participate in the case-study approach telepresence classroom without having to worry about delay or lag.

Preferred embodiments of the invention deliver a business school case method in a virtual environment. The system described herein can remove the barriers of location based learning and provides faculty and students with an array of tools that facilitates the business case method on a case-study approach telepresence platform. As described in more detail, the system described herein promotes active engagement through elements such as blackboards, hand raise, and debate mode. The system also promotes social interaction through chat, class roster and polls. The system also creates a real time environment that compels the participant and instructor to remain engaged through video production elements such as perspective view, drama cameras, and a control room. Students can stay connected where they work and live through an enterprise class network and video conferencing platform that provides multiple peer to peer connections to the virtual environment without leveraging bridging technologies.

FIG. 1 is an overhead perspective view of a case-study approach telepresence classroom, according to some embodiments of the present invention. It shows a case-study approach telepresence classroom 100, which includes a student video wall 102, a teaching station 104, and an instructor 106. The student video wall 102 includes a student image 112 for each student participating in the classroom. The teaching station 104 includes a teaching wall 108 and a teaching stage 110. The teaching stage 110 is sized proportionally with respect to the wall such that student images 112 appear life-like in size to the instructor 106.

As will be described in more detail below, the student video wall 102 can form an arc around the teaching station 104. Briefly, the student video wall 102 can be designed to facilitate instructor-to-student and student-to-student communication. In some embodiments, the wall 102 is curved such that each student image 112 has a line of sight with the instructor 106.

Also, as will be described in more detail below, the student video wall 102 can be one screen segmented into a plurality of images using computer control logic. The student video wall 102 can include several groups of student images 112. In a real classroom, an instructor has some sense of division in the classroom because of the rows and aisles. On the student video wall 102, student images 112 can be grouped into sections to simulate a real classroom. As in a real classroom, student images 112 can be organized by row and separated by dividers. As described in more detail below, the dividers can also provide additional real estate on the teaching wall to display blackboard annotations or student messages.

In some embodiments, the student video wall 102 includes as few as 30 student images 112 and as many as 100 student images 112. As described in more detail below, each student image 112 can contain a camera and speaker collection. Briefly, each student image camera provides a perspective view of the classroom from the camera's location on the wall. Each speaker also provides a point source of sound corresponding to the speaker's location on the wall.

The teaching stage 110 is where the instructor 106 generally resides. As described in more detail below, the classroom is arranged and scaled such that he or she is not limited to a confined space such as behind a desk but instead can move freely on the stage. The teaching stage 110 is also arranged and scaled such that students appear life-like in size to the instructor 106 regardless of his or her movement on the stage 110. As with the design of the student video wall, the teaching stage 110 is designed to facilitate a consistent line of sight between instructor and student. As discussed in more detail below, the teaching stage 110 is positioned such that each of the student images 112 has a line of sight to the instructor 106, regardless of the instructor's position within the teaching stage 110.

In some embodiments, the telepresence classroom does not include a teaching stage. As described in more detail below, the student wall 102 can define an area where the instructor can move around and maintain visual contact with students. Briefly, the interior of the arc can define a teaching pit where the instructor can move during a class.

The teaching wall 108 is positioned at one end of the teaching stage. As described in more detail below, the teaching wall 108 can include digital blackboards for the instructor 106. Briefly, the digital blackboards function in a similar way to real blackboards in a classroom. An instructor 106 can write on the blackboard during the class. Material from the blackboard can be displayed on a student's computer or on portions of the student video wall 102, such as in the dividers between student sections.

In preferred embodiments, student images 112 are sized such that the students appear on the student video wall 102 in a roughly similar size as they would appear in person. As described in more detail below, in addition to size, the student images 112 are oriented to minimize visual noise (e.g., bookshelves, walls, ceiling, furniture) and to maximize the student's profile.

The student images 112 are also positioned so that there is not a front or back of a classroom. An instructor is presented with all of the students at once (e.g., students do not just appear when they are speaking). In a real classroom, a student can try to sit in the back row to avoid interaction with the instructor or other students. A instructor may have to walk around the classroom to counter the effects of a front and back row. On the student wall 102 each student in the same vertical column can be the same distance away from the instructor. For example, in a column of three students, the student at the top, middle and bottom are generally the same distance away from the instructor. Eliminating the front and back row on the student wall 102 allows an instructor to engage with students equally regardless of their seat on the student wall 102.

An instructor can also have a control desk located near the teaching stage 110. As described in more detail below, the control desk allows the instructor to control the content displayed on the student wall 102. Briefly, the instructor can move content from the teaching wall 108 to the student wall, as well as display poll results and messages.

The classroom can also have one or more drama cameras. As described in more detail below, drama cameras provide views of the classroom to supplement a student's perspective view. Briefly, the drama cameras can provide a variety of angled shots of the classroom and the instructor (e.g., follow the instructor around the classroom, focus in on the instructor, provide a wide angle shot, a view of the entire teaching wall, and an overhead view of the classroom).

In some embodiments, a student can participate in the classroom as an observer. An observer can access video and audio from the course respond to a poll or use other less active features of the class, but would not be presented on the screen.

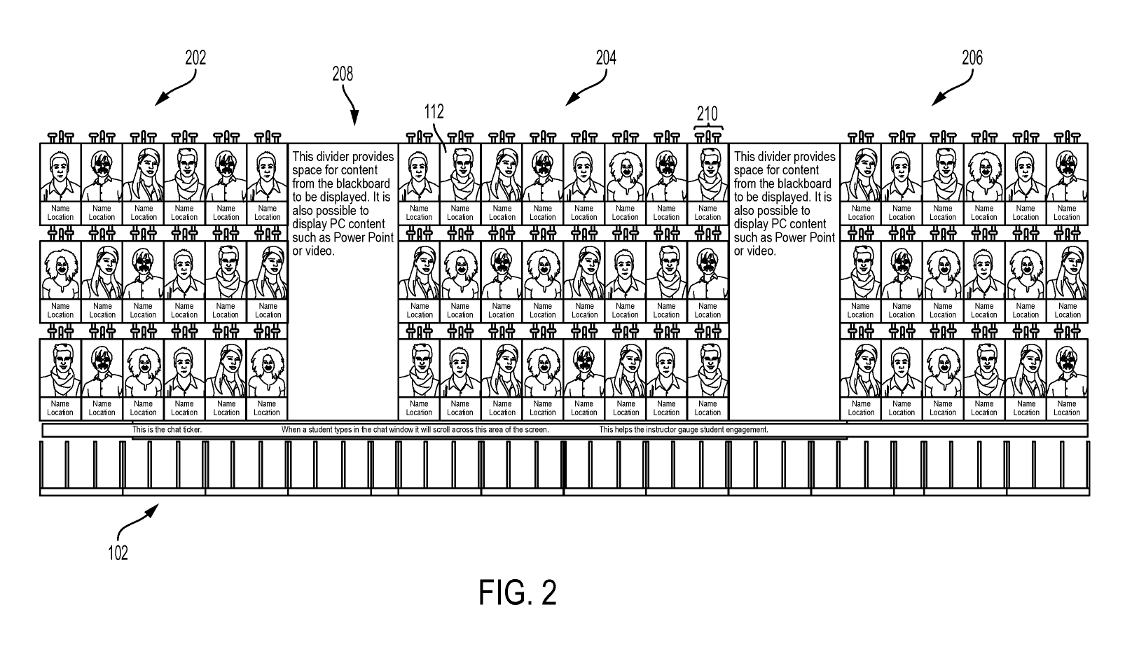

FIG. 2 is a two dimensional diagram depicting a student wall, according to some embodiments of the present invention. It shows a student video wall 102 including a left section 202, a middle section 204, a right section 206, and a divider 208. FIG. 2 also shows a camera and speaker image 210 for each student image 112.

In the context of FIG. 2, there are 60 student images 112 that are grouped into three sections 202 204 206. Rather than have a teaching wall 102 with 60 continuous student images 112, the teaching wall 102 has a left section 202 with 20 student images 112, a middle section 204 with 20 student images 112, and a right section 206 with 20 student images 112. In some embodiments, dividers 208 separate the sections. The dividers 208 can be used to display blackboard annotations or other classroom materials. As described in more detail below, blackboard annotations can be moved from the teaching wall onto the dividers 208. Briefly, the display of blackboard annotations on the dividers 208 allow a instructor to keep eye contact with the students while accessing the blackboard annotations.

Each student image 112 includes a camera and speaker collection 210. Each camera provides a perspective view of the classroom from its respective location on the wall. For example, a camera corresponding to student image 112 one side of the wall can have a different perspective view from a camera corresponding to a student image 112 on another side of the wall. Each speaker outputs sound associated with its student image 112. Preferably, the microphones for each student remain live throughout the entire lecture. This gives the instructor the sense that all of the students are present in the room at all times. Student sounds can include a student speaking (e.g., answering a question, asking a question, making a comment) or ambient noise in the student's environment (e.g., typing sounds, coughing, rustling of papers, laughing, groaning). Each speaker provides a source of sound distinct to its location on the wall student video wall 102. For example, from an instructor's point of view, noise from a student's speaker in the left section sounds like it came from the left side of the room, while noise from a student's speaker in the right section sounds like it came from the right side of the room.

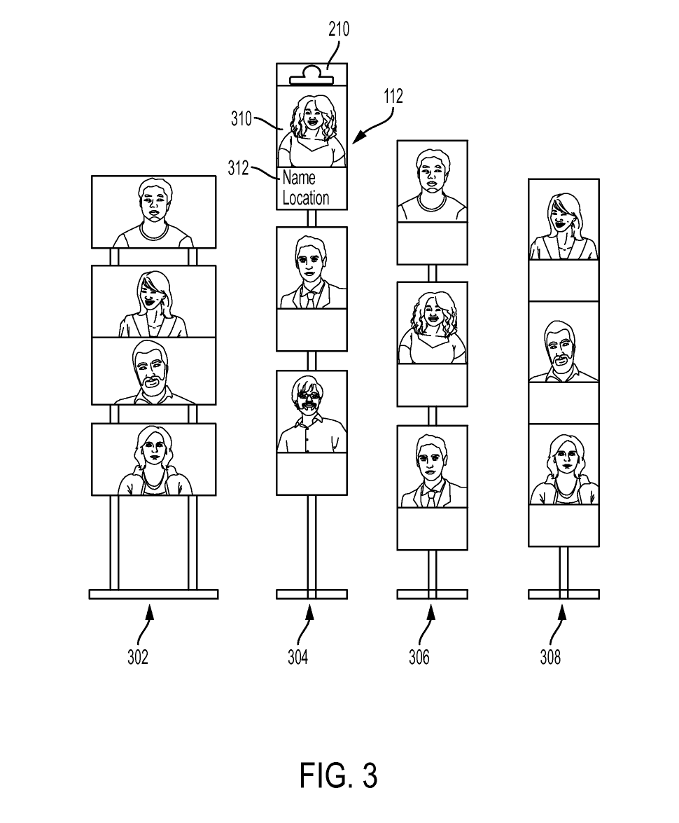

FIG. 3 is a layout depicting landscape and portrait views of student images, according to some embodiments of the present invention. It shows a student image 112 including a camera and speaker collection 210, a remote location student video feed 310 and information about the student 312. FIG. 3 also shows remote location student video feeds 310 in landscape orientation 302 and in portrait orientation 304 306 308.

As described above, a student image 112 can include a camera and speaker collection 210 to capture a perspective view of the classroom and to provide a perspective sound source. In portrait mode, there is more space above and below the remote location student video feed 310 to place the camera and speaker collection. The camera and speaker collection 210 can be placed anywhere within the student image 112. In FIG. 3, the camera and speaker collection 210 is positioned above the window for a remote location student video feed 310.

The remote location student video feed 310 shows a video of the student associated with a student image 112. As described above, the remote location student video feed 310 can serve several purposes. The remote location student video feed 310 provides a realistic view of the student for both the instructor and other students in the virtual classroom. The remote location student video feed 310 can also provide visual feedback for the student so that the student is conscious at all times how he or she appears in the classroom. In some embodiments, a camera operatively connected to the student's computer captures the image feed of the student. In some embodiments, if the student does not have a camera or has an inoperable camera, an avatar may be substituted for the remote location student video feed.

The student image 112 also includes student information 312. Student information 312 can include the student's name and location. Displaying student information 312 on the student video wall can be equivalent to providing an instructor with a seating chart in a real classroom. The student information 312 provides the instructor with a way to call on students, furthering student engagement. Student information can also include an indication of the student's status in the classroom.

Depending upon the embodiment, a remote location student video feed 310 can be oriented either as landscape 302 or portrait 304 306 308 on the teaching wall 102. In some embodiments, portrait 304 306 308 is utilized to maximize the amount of space taken up by the student in the image. In some embodiments, landscape 302 shows more background noise (e.g., bookshelves, pictures, walls, lights) than portrait mode 304. Reducing the amount of background noise can reduce the amount of distraction for the instructor and enable the instructor to focus more on the students and the lecture. The remote location student video feed 310 can be approximately 1-3 feet wide and 2-4 feet long.

A remote location student video feed 310 can also be sized such that the remote location student video feeds 310 are similar in size to real students. The remote location student video feed size can be a function of the size of the display and the teaching stage. For example, the remote location student video feed 310 can have a profile (e.g., head and shoulders) similar in size to a real person sitting in that location. This feature helps to create a more realistic classroom environment from an instructor's point of view.

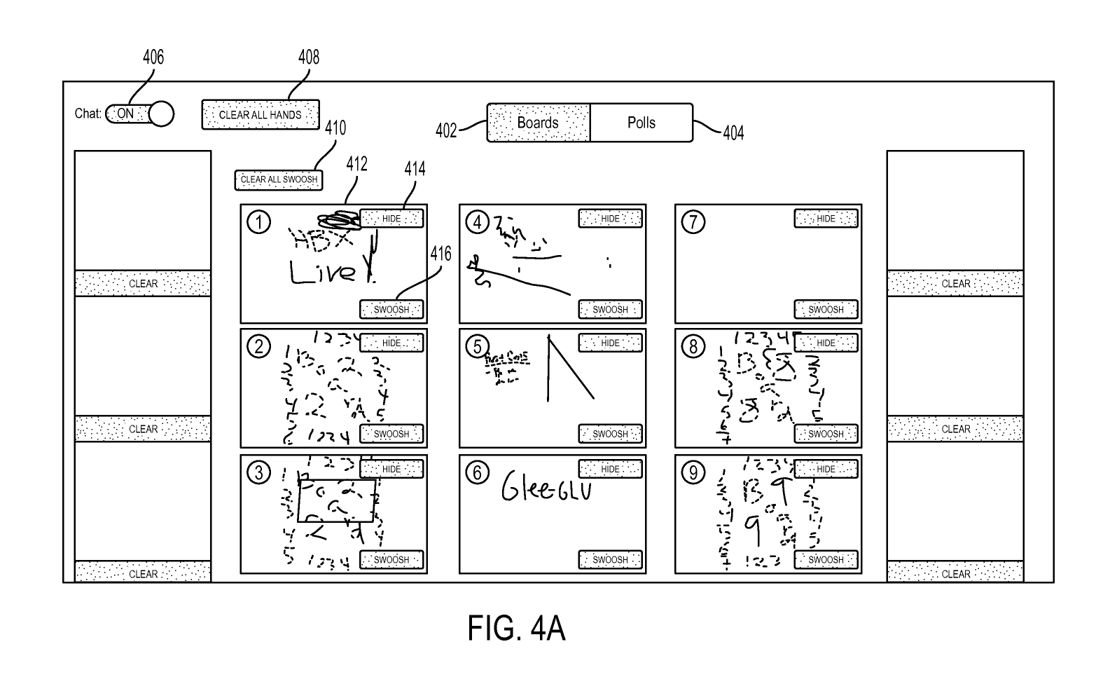

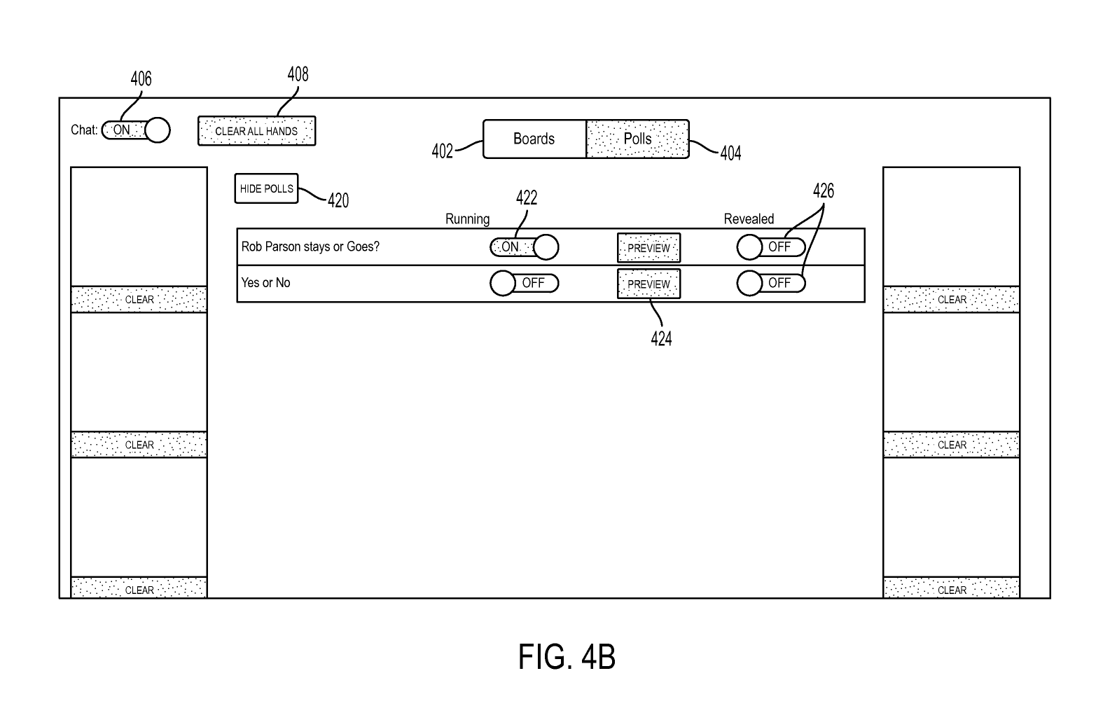

FIG. 4A is a screenshot depicting a boards view on a control desk, according to some embodiments of the present invention. It shows a toggle view between a boards 402 and polls 404, a chat switch 406, a clear all hands feature 408, a clear all swoosh feature 410, and a miniature teaching board 412 including hide 414 and swoosh 416.

A boards view 402 allows an instructor to view on the control desk content displayed on the teaching wall 108. The boards view 402 includes a chat switch 406. As described above, chats can be displayed on the student wall 102. The chat switch 406 allows an instructor to choose when to display students' chats on the wall 102. For example, when the chat switch 406 is on, student chats appear on the wall 102. When the chat switch 406 is off, student chats do not appear on the wall 102.

The boards view 402 also includes a clear all hands feature 408. As described below, students can raise their hands during class. Briefly, a light indicator can turn on when a student chooses to raise his or her hand. The clear all hands feature 408 allows an instructor to clear all light indicators from the student wall 102.

An instructor can have a miniature view of teaching boards 412. The instructor can see in the miniature teaching boards 412 annotations made on the blackboards. For example, annotations made on blackboard 1 can appear on miniature teaching board 1. The miniature teaching board 412 also has a hide 414 and a swoosh 416 feature. The hide feature 414 allows an instructor to prevent students from viewing content on a blackboard. For example, an instructor, prior to class can make annotations on all of the blackboards and choose to release them one at a time. The swoosh feature 416 allows the instructor to display blackboard annotations on the student wall. As described above, displaying blackboard annotation on the student wall allows an instructor to lecture to the class without having to turn around and reference blackboard annotations on the teaching wall.

FIG. 4B is a screenshot depicting a polls view on the control desk, according to some embodiments of the present invention. It shows a polls toggle 404, a hide polls feature 420, a running switch 422, a preview feature 424 and a revealed switch 426.

An instructor can create and run polls from the control desk by choosing a polls toggle 404. An instructor can create polls before the start of a lecture and choose to hide polls 420 until he or she chooses to reveal a poll to students. An instructor can also pick a time frame to run the polls. A running switch 422 allows an instructor to choose when to start and stop a poll. A preview feature 424 allows an instructor to view a poll result at the time he or she enables the preview feature 424. An instructor can also reveal the poll to the students in the class by enabling a revealed switch 426.

Polls can relate to topics discussed in class or topics that relate to the lecture. Polls can also relate to comments made by other students.

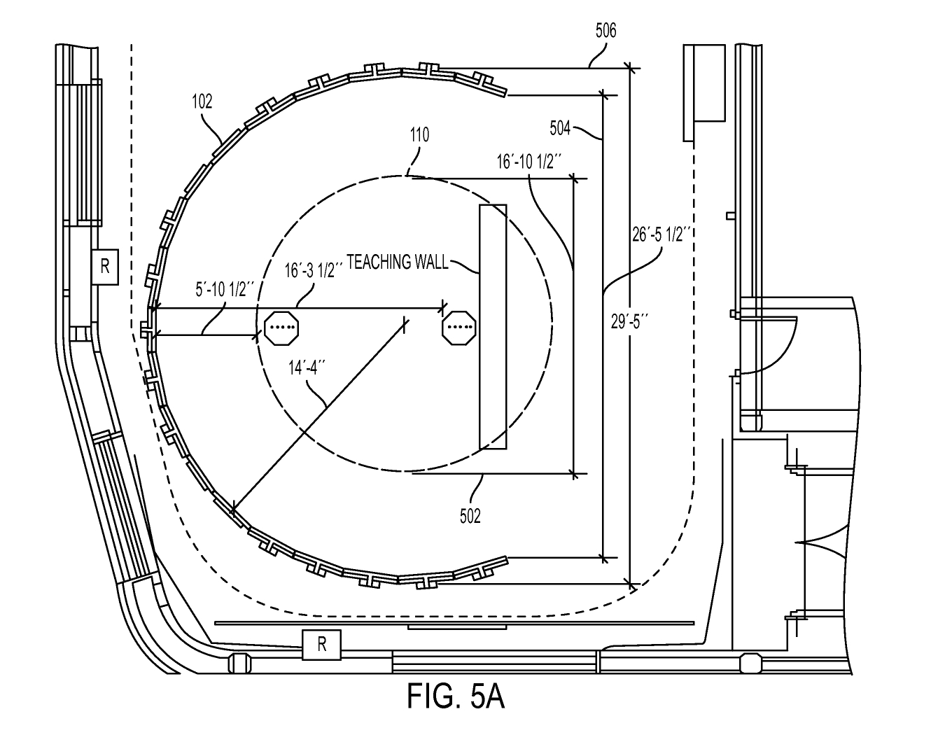

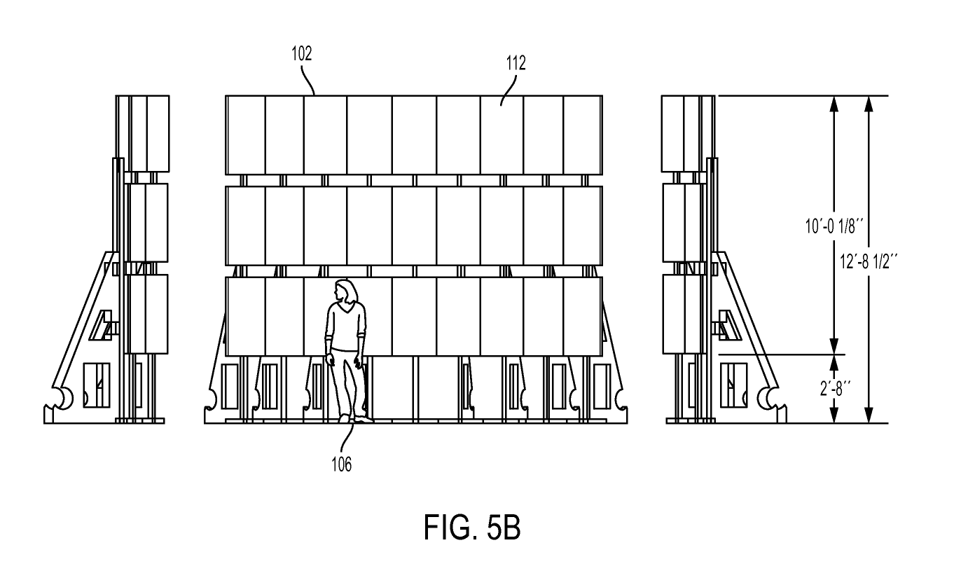

FIG. 5A is a plan depicting a student video wall and a teaching stage, according to some embodiments of the present invention. FIG. 5A shows a diameter of the teaching stage 502, a distance between the ends of the student wall 504, and a diameter of the student wall 506.

In some embodiments, the student video wall 102 is semi-circular in shape. The teaching stage 110 can also be semi-circular in shape. In some embodiments, the teaching stage 110 is partially surrounded by the student video wall 102. As described above, in some embodiments, the student video wall 102 and the teaching stage 110 are designed such the instructor has a line of sight with each of the students regardless of the instructor's position within the teaching stage 110. The student wall 102 can be an arc that exceeds 180 degrees (e.g., 210 degrees) such that the ends of the teaching wall are at a distance 504 less than the diameter of the student wall 506. In some embodiments, the student wall 102 can be an arc of less than 180 degrees (e.g., 90 degrees) such that the ends of the student wall are at a distance greater than the diameter of the student wall. For example, the arc can comprise a semi-circle which is less than half the perimeter of a circle.

The teaching stage 110 and student wall 102 are also arranged such that students appear life-like in size when the instructor is on the teaching stage 110. In one embodiment, having a stage with approximately a 16-17 foot diameter 502, a student wall with approximately a 27-32 foot diameter 506, and positioning the stage approximately 5-6 feet away from the wall allows students and the instructor to maintain a line of sight, while providing the instructor with a life-like sized view of the students. The teaching stage 110 and student wall 102 can also be sized proportionately larger or smaller. The student image size can grow or shrink to keep the students a life-like size relative to the instructor's vantage point.

In some embodiments, the telepresence classroom does not include a stage, and the student wall 102 defines a pit area where the instructor can move around during a class. For example, an instructor can move (e.g., walk, crouch, roll, perform calisthenics) right up to the student wall. In some embodiments, giving the instructor a greater amount of space to move provides the instructor with more freedom for self-expression, enhancing the unscripted and spontaneous quality of the class.

FIG. 5B is a diagram depicting an instructor and a student wall.

As described above, student images 112 can be sized such that they appear life-like in size to an instructor. The student wall can be a solid display or include segments. In some embodiments, the wall can be approximately 9 to 15 feet high. In some embodiments, the screen portion of the student wall can be approximately 7 to 13 feet high, while the base portion can be 2 to 6 feet high.

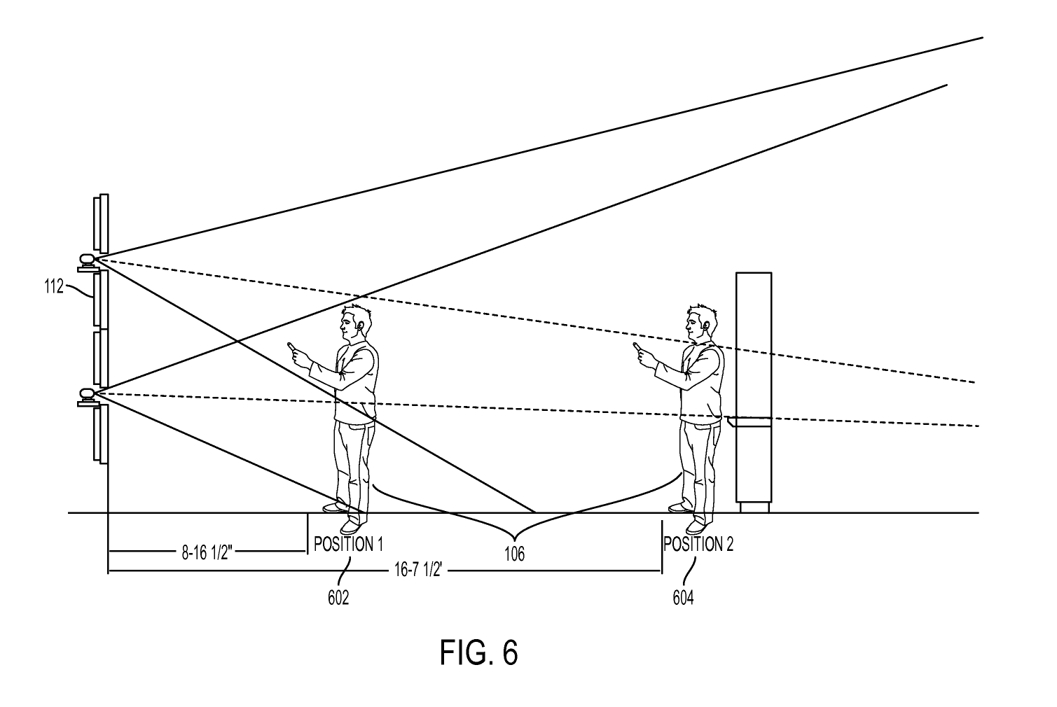

FIG. 6 is a side view of the classroom, according to some embodiments of the present invention.

The teaching stage 110 can be positioned so that each student image 112 on the student video wall 102 has a line of sight to the instructor 106. For example, position 1 602 indicates a position of the instructor at an edge closest to the student wall such that the instructor is within the optimal viewing angle of the student's perspective camera. Position 2 604 indicates a position farthest from the student wall such that the instructor is still within the optimal view from the student's perspective. The lines in the figure indicate the top and bottom angle of view of the camera with the dotted line indicating the center field of view. The field of view for a student can also depend on his or her location on the wall. As in a classroom, where a student's choice of seat affects his or her field of view of the instructor, a student sitting in the upper camera position has a field of view that is different from the field of view for a student sitting near the lower camera. The measurements at the bottom of the figure reference the minimum distance and maximum distance that generally are not exceeded within the teaching area to maintain optimal viewing from the student's perspective. The measurements can vary depending on the size and curvature of the student wall 102. For example, with a student wall 102 of the dimensions as illustrated in FIG. 5A, the minimum distance is approximately 7 feet and the maximum distance is approximately 22 feet. In some embodiments, when the instructor deviates from an optimal viewing position, drama cameras can supplement the field of view captured from student perspective cameras.

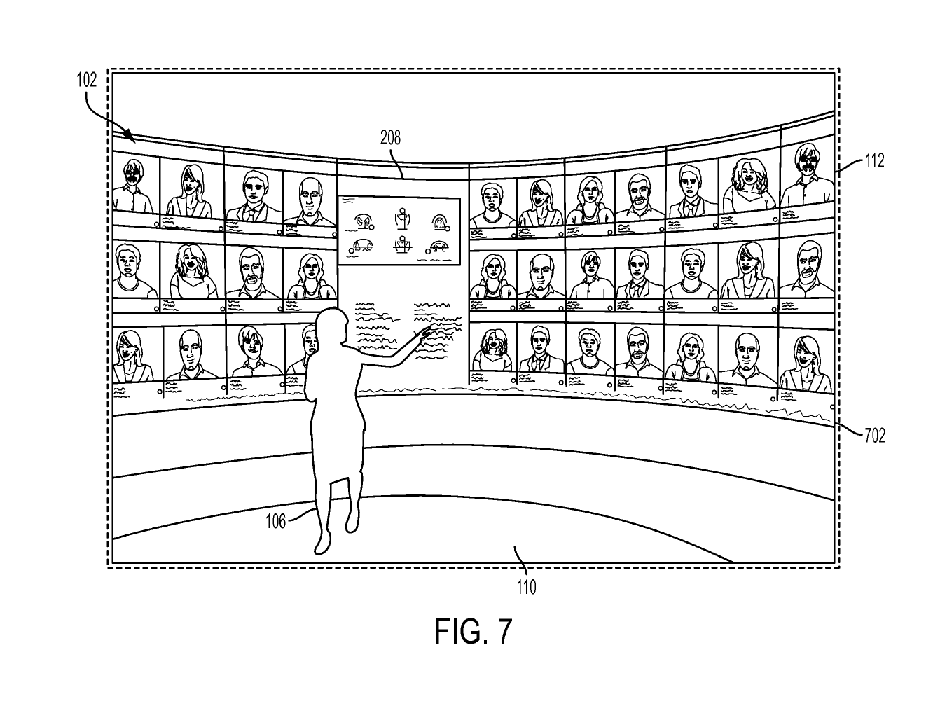

FIG. 7 is a perspective view of the teaching wall, according to some embodiments of the present invention. It shows a student video wall 102 with student images 112, a divider 208 between student image sections, a ticker 702 at the bottom of the student video wall 102 and instructor 106 and the teaching stage 110.

In some embodiments, there can be more than one divider on the student video wall 102. There can be two dividers such that the student video wall 102 is split into three sections. As shown in FIG. 7 the divider 208 can display images drawn by the instructor on the teaching wall 104. Displaying images from the blackboard on the student video wall 102 can be advantageous so that the instructor can face the students while discussing annotations on the blackboard. With the blackboard annotations present on the student video wall 102, the instructor does not need to turn around constantly to refer to the blackboard. Having the instructor face the class and moving around while speaking makes the classroom feel more real and life like for the instructor, and a more engaging presentation for the students.

In some embodiments, the divider 208 can also display other text related to the class (e.g., chats between students, posts on message boards, teaching wall content). Displaying text related to the class on the divider 208 allows the instructor to read these messages while addressing the class without turning his or her back on the students. Similarly, the divider 208 facilitates having the instructor face the class while speaking and helps to increase student engagement. The divider also provides the instructor with a visual break in the teaching wall. As in a traditional classroom where students are divided by aisles, the dividers divide the panel of students.

The student ticker 702 is another location on the student video wall 102 to display information. Text in the ticker 702 can be running across the screen and updated in real time. For example, the ticker 702 can show recent chats between students or recent posts to a message board. The ticker 702 complements the dividers 208 and allows display of more than one element at a time. For example, the instructor can view annotations from the blackboard on the divider 208 at the same time as viewing chats in the ticker 702. Again, utilizing the ticker 702 with the dividers 208 allows the instructor to face the class while having access to blackboard annotations and class messaging. The divider portion of the wall is also designed to display content such as Power Point slides and videos with the same idea that the instructor can reference the content while looking directly at the students.

The student ticker 702 can also inform an instructor about the level of student activity. For example, an instructor can see whether students are chatting and engaging with one another at a high or low rate. An instructor can modify his or lecture style based on the level of chatter on the ticker.

The instructor can also respond to comments posted on the ticker. In a traditional classroom, an instructor can elicit several responses from a class and pick the response most relevant or useful to build a discussion. Similarly, an instructor can choose a message from the ticker to build a discussion. As described above, in a case-study approach, the emphasis is on learning through student exploration and discussion. The ticker helps an instructor to choose among various students' thoughts and to guide student discussion.

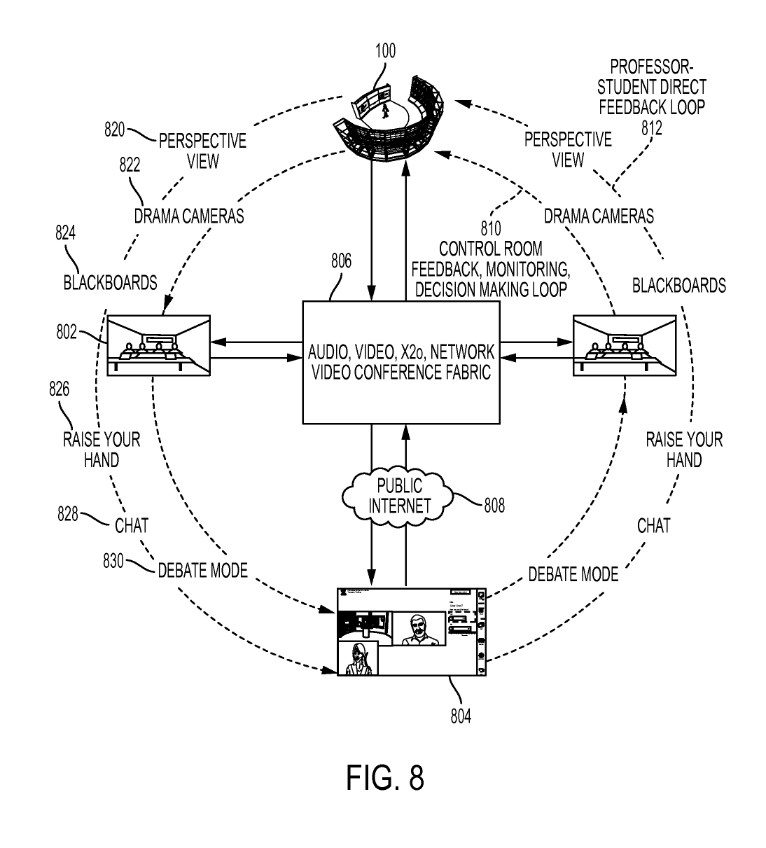

FIG. 8 is a conceptual diagram of the case-study approach telepresence platform, according to some embodiments of the present invention. It shows the case-study approach telepresence classroom 100, a control room 802, a user platform 804, an audio/video/video conference switching fabric 806, and public internet 808. FIG. 8 also shows elements available on the platform, including a perspective view 820, a drama camera 822, a blackboard 824, raise your hand 826, chat 828 and debate mode 830. FIG. 8 further shows which the elements are either directly connected between student and classroom 812 or monitored by the control room 810.

As shown in FIG. 8, the audio/video/video conference switching fabric 806 (e.g., X2O, Evertz EQX) manages video and audio stream transfers between students 804, the control room 802 and the case-study approach telepresence classroom 100. As described in more detail below, the audio/video/video conference switching fabric 806 outputs different combinations of video streams depending on an element (e.g., 820, 822, 824, 826, 828, 830) invoked by the instructor, control room or student.

In some embodiments, the control room 802 can decide what information from the classroom should be sent to the students. The control room 802 can also monitor and control activity in the classroom. As shown in FIG. 8, the drama camera 822, and debate mode 830 are the two elements most likely monitored and controlled by the control room 802. Examples of control room monitoring and control can include the following: while in full screen view of teacher, control room is switching between cameras to capture and evoke the emotion of the moment; the teacher may ask several student to engage in a debate between each other while the instructor plays a more passive role; the control room may switch to a camera view of the entire teaching wall for the benefit of the students independent of the teacher; the control room may switch to a full screen view of one student who being asked to provide their comments and analysis on a case study; and the control room may switch to a view of one student and the instructor when engaged in a longer conversation for the benefit of the rest of the class.

In some embodiments, the drama camera 822 can be used to capture events during a lecture. The control room can send to students the drama camera feed most likely to keep students engaged in the lecture. For example, the control room 822 may decide to use the drama camera to follow the instructor around the room. If an instructor moves animatedly around the teaching stage, one of the drama cameras can stay focused on the instructor and follow her as she moves. The control room can decide to send this drama camera feed to the students to supplement their individual perspective view. As another example, the instructor can decide to spend a lot of time at the blackboard. The control room can decide to focus the drama camera on the instructor at the blackboard and send the blackboard drama camera view to students.

Debate mode 830 includes sending to each user platform 804 video streams corresponding to students involved in a debate. The control room can decide 810 when to begin a debate mode 830 video stream and how many participants to include. For example, the control room can decide 810 not to initiate debate mode 830 if the control room decides 810 that a conversation between multiple students and an instructor only lasts momentarily. Conversely, the control room can decide 810 to initiate debate mode 830 if it feels the conversation between multiple students and the instructor is prolonged. Having the control room focus on students involved in a debate can enhance student engagement of students not involved in the debate.

As described in more detail below, the information selected by the control room is sent from the audio/video/video conference switching fabric 806 via the internet 808 to each of the students participating in the classroom. Briefly, each of the students can receive some feeds that are identical to what other students receive (e.g., drama camera feeds, blackboard feeds, debate mode views). Each student can also receive a unique feed including their own image feed and their own perspective view. The feeds received by each of the students can appear in one or more windows in a user platform.

As shown in FIG. 8, some elements are not edited by the control room 802. Perspective view 820, the blackboard 824, raise your hand 826, and chat 828 can be direct communication between instructor and student 812 or between students. For example, in some embodiments, the audio/video/video conference switching fabric 806 can directly route video, audio, and text feeds sent by the students 804 to the student video wall 102. A student's image feed can be displayed directly on the student video wall 102, or a student's chat can be displayed on the ticker on the student video wall 102. A student's chat can also be displayed on another student's user platform 804.

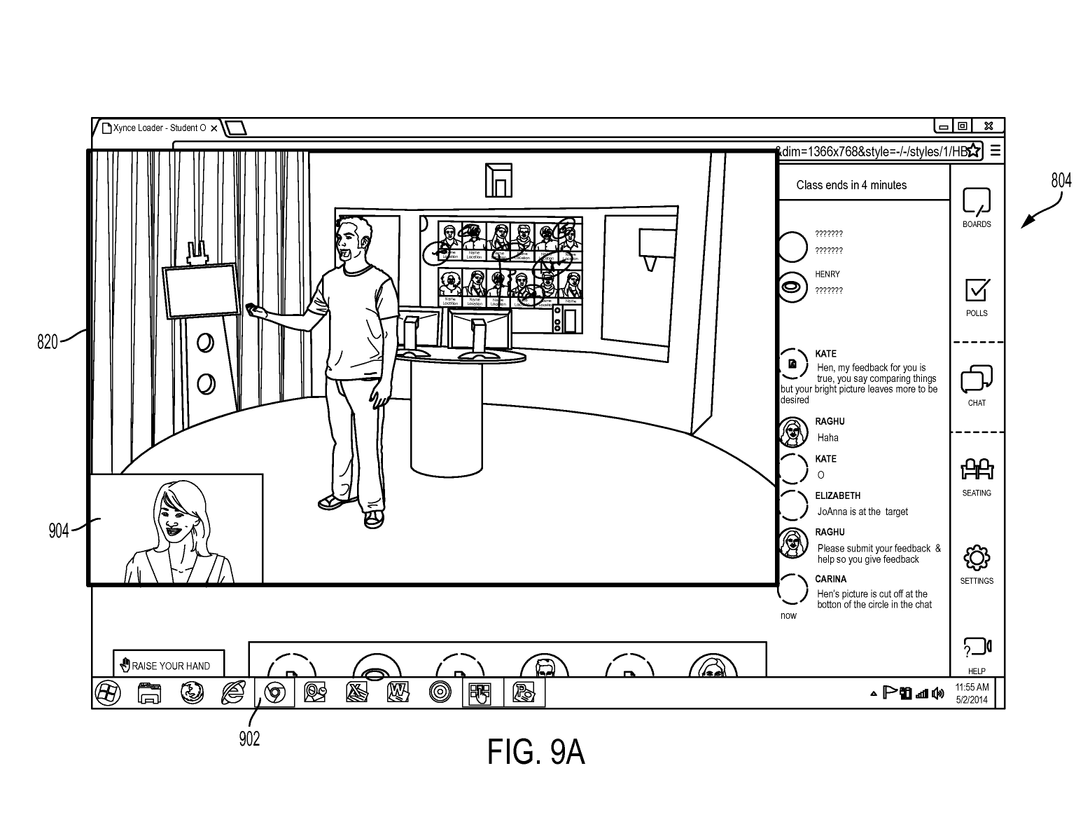

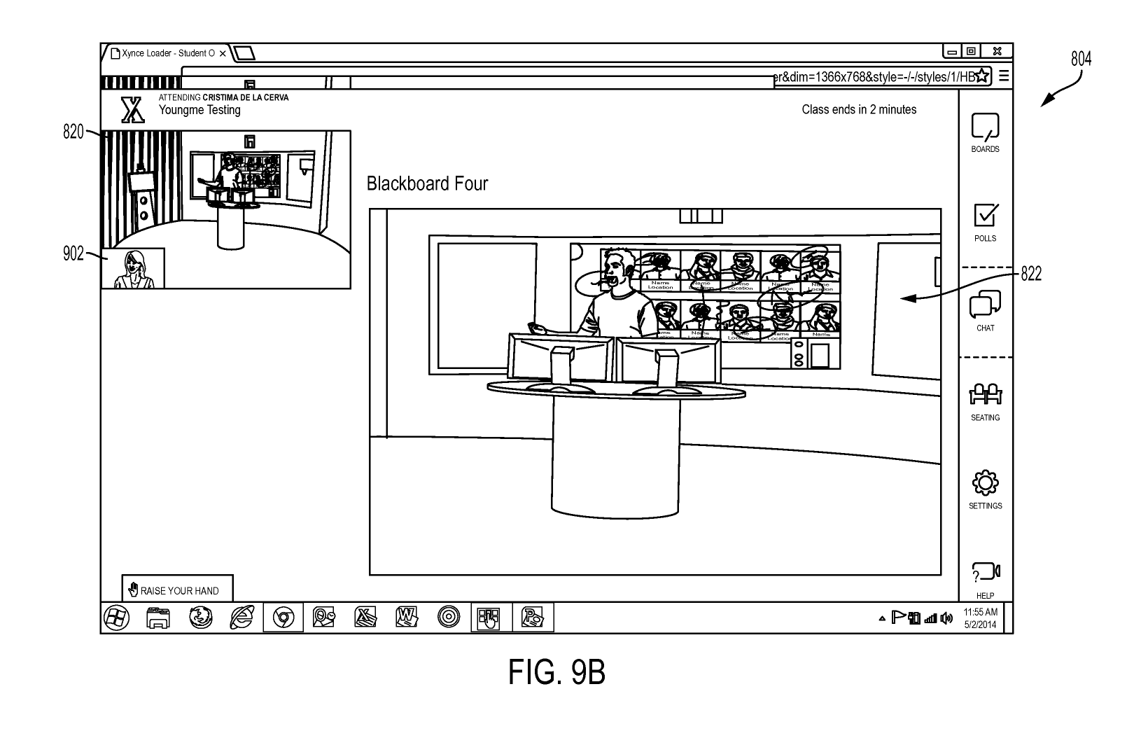

FIG. 9A is a screenshot of a student computer platform including a student perspective view, according to some embodiments of the present invention. It shows a web browser 902, user platform 804, a window showing a perspective view 820, and a student image window 904.

As discussed previously, a perspective view 820 is a view from a student's camera. For example, if there are 60 students in the classroom, there can be 60 perspective views, one from each of the students' modules 112.

The user platform 804 is launched on a user's computer in a web browser 902. The web browser 902 can be any web browser (e.g., Chrome, Internet Explorer, Firefox, Safari). The user platform 804 may be created using any video/user interface platform (e.g., X2O from X2O Media).

The perspective view 820 shown in FIG. 9A is from the perspective of the student pictured in the student image window 904. In some embodiments, each perspective view 820 includes the associated remote location student video feed 310. In some embodiments, a student image window 904 includes a remote location student video feed 310 that is shown to the student so that they can adjust their camera angle, if necessary. The remote location student video feed 310 is also shown to remind the student of how they look on the student video wall 102. As mentioned above, showing a student how they look at all times during a class can incentivize the student to look more engaged throughout the lecture.

FIG. 9B is a screenshot of a user platform, which includes both a perspective view and a drama camera view, according to some embodiments of the present invention. It shows a user platform 804, a window showing a perspective view 820, a window showing a student's image 904, and a window showing a drama camera view 822.

Another element available on the platform is a drama camera view 822. As mentioned above, the drama camera 822 can provide a close up view of the instructor, a close up view of the blackboards, or of any other aspect of the classroom that may be a point of interest 822. The drama camera view 822 and the perspective view 820 both show real time footage from the classroom, just from different perspectives. The drama camera view 822 can include cameras installed within the classroom in various locations or held by an operator capturing the lecture. As discussed above, both the position of the drama camera 822 and the decision about which camera feed to send to students can be decided by the control room 802.

In some embodiments, the drama camera view 822 can become the main window in a user platform 804. The control room 802 can decide when to send the drama camera feed to a student's computer. When the control room 802 decides to send a drama camera view 822, the window containing the user's perspective view 820 shrinks and moves off to the side.

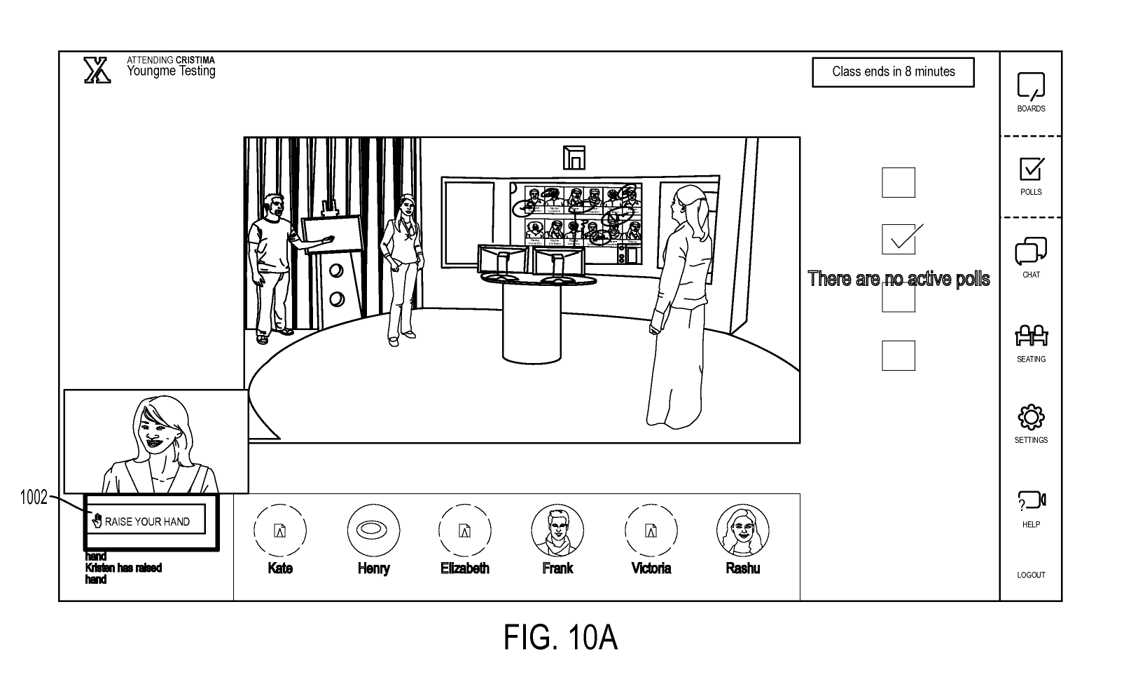

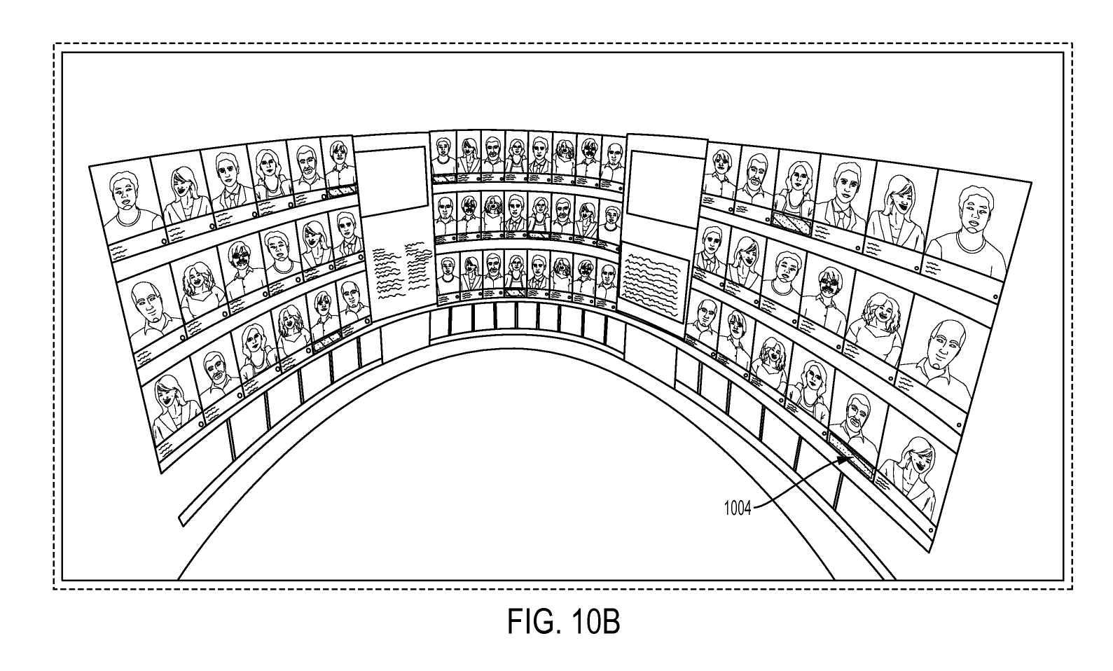

FIG. 10A is a screenshot of a student's computer including a raise your hand feature, according to some embodiments of the present invention. FIG. 10B is a perspective view of the classroom depicting a raise your hand indicator.

Referring to both figures together, another element available on the platform is a raise your hand icon 1002. Raise your hand 826, which is triggered by a student selecting the raise your hand icon 1002, is a student initiated action indicating that a student wants to speak. Similar to a traditional case-study approach classroom, students generally do not speak in the case-study approach telepresence classroom until called on by an instructor. A student can select the raise your hand icon 1002 on the user platform 804 to indicate that they would like to speak in class.

When a student selects the raise your hand icon 1002, the instructor can see an indicator 1004 on the student video wall when a student selects the raise your hand icon 1002. The instructor can also see the order in which students raised their hands. For example, the first student to select the raise your hand icon 1002 has his or her indicator 1004 light up first. In some embodiments, the indicators on the student video wall 1004 stay illuminated until the instructor calls on a student. In some embodiments, the indicators disappear from the student video wall after a certain amount of time. As described above in FIG. 4, an instructor can clear all the raise your hand indicators from the control desk.

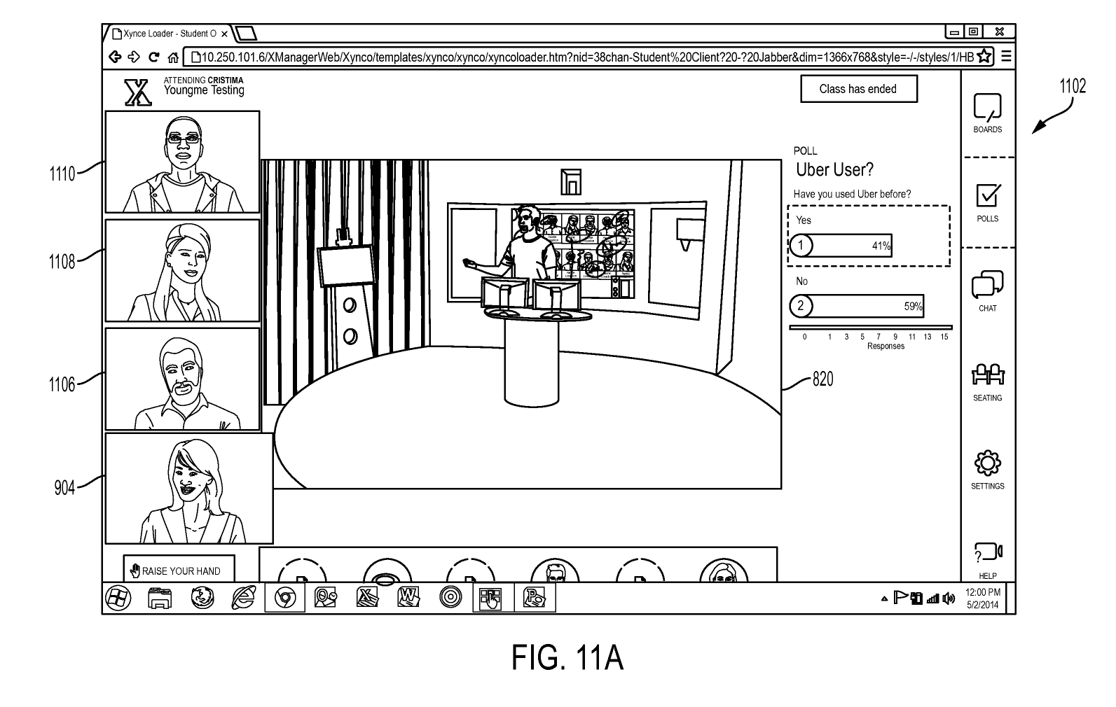

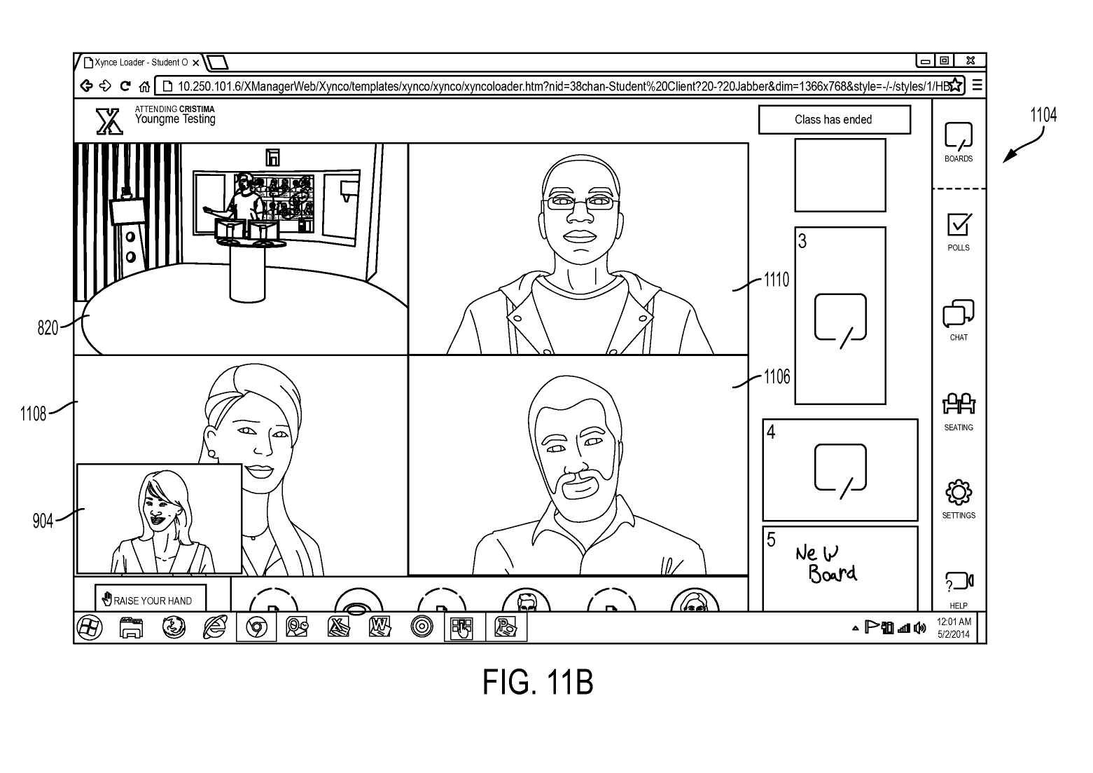

FIG. 11A is a screenshot of a student's computer depicting debate mode with a student perspective view in the main window, according to some embodiments of the present invention. FIG. 11B is a screenshot of a student's computer depicting debate mode with a student perspective view as one of four tiles, according to some embodiments of the present invention. Referring to them together, they show a perspective view 820 of a student, an image feed of the student 904, an image feed of a second student 1106, an image feed of a third student 1108, and an image feed of a fourth student 1110.

As discussed above, another element available on the platform is debate mode 830. Debate mode 830 allows the control room to focus in on the students who are participating in a debate or conversation. Debate mode 830 can arise from multiple students raising their hand and the instructor choosing to involve only a few students (e.g., approximately 1 to 3 students) in a conversation. For example, the control room can start debate mode 830 based on a verbal cue from the instructor (e.g., “Control room, I would like to have John, Bill and Sue debate the current issue.”). Debate mode can also arise when a small group of students (e.g., approximately 1 to 3 students) are engaged in a discussion with the instructor. In some embodiments, the control room 802 makes a decision as to when debate mode 830 starts. When the control room 802 determines that debate mode is appropriate, as described above, the control room can display images of the students involved in the debate.

In the first version of debate mode 1102, a main window shows a student's perspective view 820. In smaller windows on the side are an image of the student 820, an image of the second student 1106, an image of the third student 1108, and an image of the fourth student 1110. The other three students 1106 1108 1110 are engaging in debate mode with the instructor.

In the second version of debate mode 1104, the student's perspective view and the other three students' image feeds 1106 1108 1110 are shown in equal-sized windows. The student's own image feed 904 is shown in a small window in the bottom left hand corner.

The control room can make the decision whether to show version 1 1102 or version 2 1104 of debate mode. The control can decide between debate mode versions based on the number of participants and the length and intensity of the group discussion. Depending on the control room's decision, different video stream layouts are displayed on a student's computer.

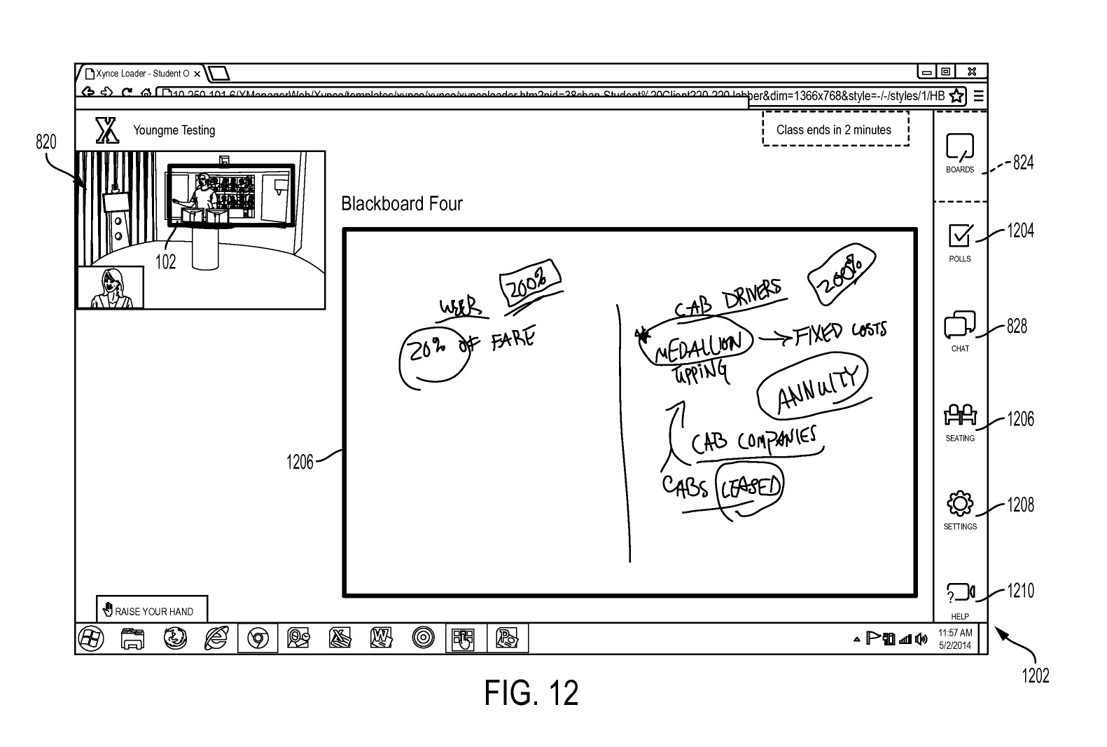

FIG. 12 is a screenshot depicting the blackboards feature, according to some embodiments of the present invention. It shows an option bar 1202, which includes the blackboards feature 824. The option bar 1202 also includes polls 1204, chat 828, seating 1206, settings 1208 and help 1210.

As discussed briefly above, another element available on the platform is blackboards 824. Providing a blackboard feature simulates a student's interaction with a blackboard in a real classroom. A student can choose to focus on a particular blackboard while listening to the lecture. A student can also look to a blackboard previously used by the instructor to supplement note taking. Another option is for the student to pull up all of the blackboards to view at once.

When a student selects blackboards 824, a board on the instructor's digital blackboard is displayed in a student's main window. As described above, the instructor can also choose which of the blackboards to display. In some embodiments, the board shown is selected by the control room 802. In some embodiments, the control room selects a blackboard currently being used by the instructor. In some embodiments, the control room selects a blackboard referenced by the instructor. The control room can take the blackboard feed and route it through the switching fabric for display at a student's computer.

In some embodiments, there are nine blackboard views. In a regular classroom, an instructor can have nine physical blackboards including three physical blackboards side by side, each with two sliding sections. Emulating a regular classroom, the teaching wall in the case-study approach telepresence classroom can include three physical blackboards. Each physical blackboard can further include three screens for the instructor to switch between. In some embodiments, the instructor can swap out screens by swiping the screen aside.

As shown in FIG. 8, when a user selects the blackboards feature 824, the main window shows the blackboard 1206. The user has the ability to choose any blackboard he or she wants to view while the instructor has the ability to erase the boards as needed. In this figure, the blackboard matches the blackboard as shown on the teaching wall 102 in the student perspective window 820.

The student can also elect to see all nine blackboards. A side window may display smaller versions of the blackboards. The student can scroll through the blackboards and pick one to display.

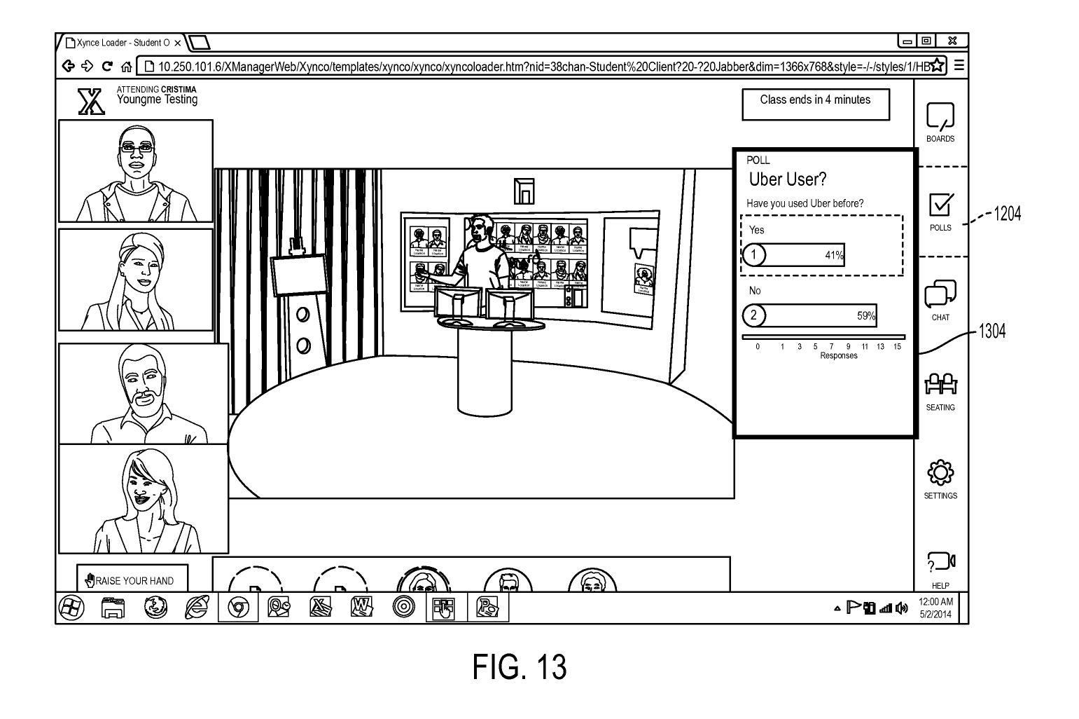

FIG. 13 is a screenshot of a student's computer depicting a polls feature, according to some embodiments of the present invention. It shows the polls feature selected 1204 and a corresponding polls result 1304 shown in a window in the browser.

As mentioned above, another element available on the platform is the polls feature 1204. When a user selects the polls feature, a window can appear within the browser to show the results of the most recent poll. At any point in the lecture, the instructor can conduct a poll. Polls can include topics related to the lectures or reactions to a student comment or discussion.

Polls help to promote the social element in a classroom. An instructor in a non-virtual classroom may ask for a show of hands during class to get a sense of how students feel about a topic. An instructor may also ask for a show of hands to highlight a particular point in the class and to increase student engagement at that moment in class. The polls feature 1204 can serve a similar purpose. An instructor can conduct a poll for an important topic, or conduct a poll when the instructor senses that student engagement is waning.

The polls can be created on the fly or loaded prior to class and are usually be relevant to the case being discussed. When the instructor decides to use this feature he or she can reveal the poll to the students via an instructor control section. The students can select the poll icon when asked by the instructor in order to interact with the polling feature. Once the students have voted the instructor can close the voting. The instructor can also show the results at which time the results become visible to the students. The instructor may also chose to preview the poll from their control section before revealing the results to the students.

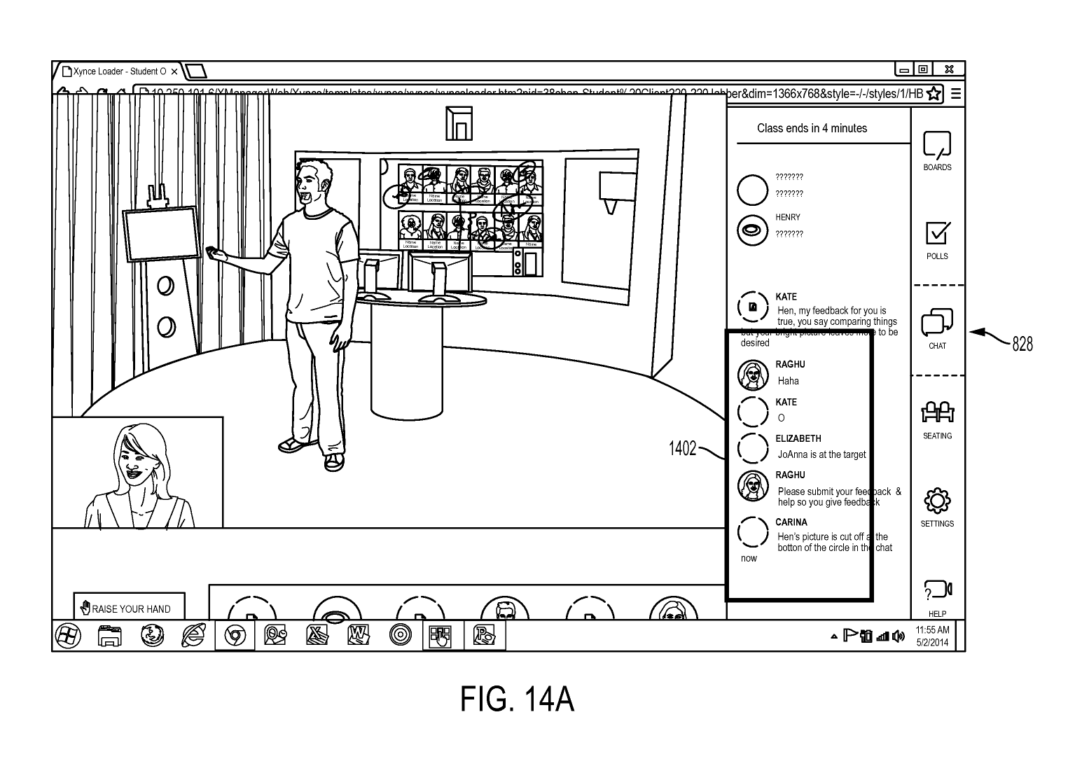

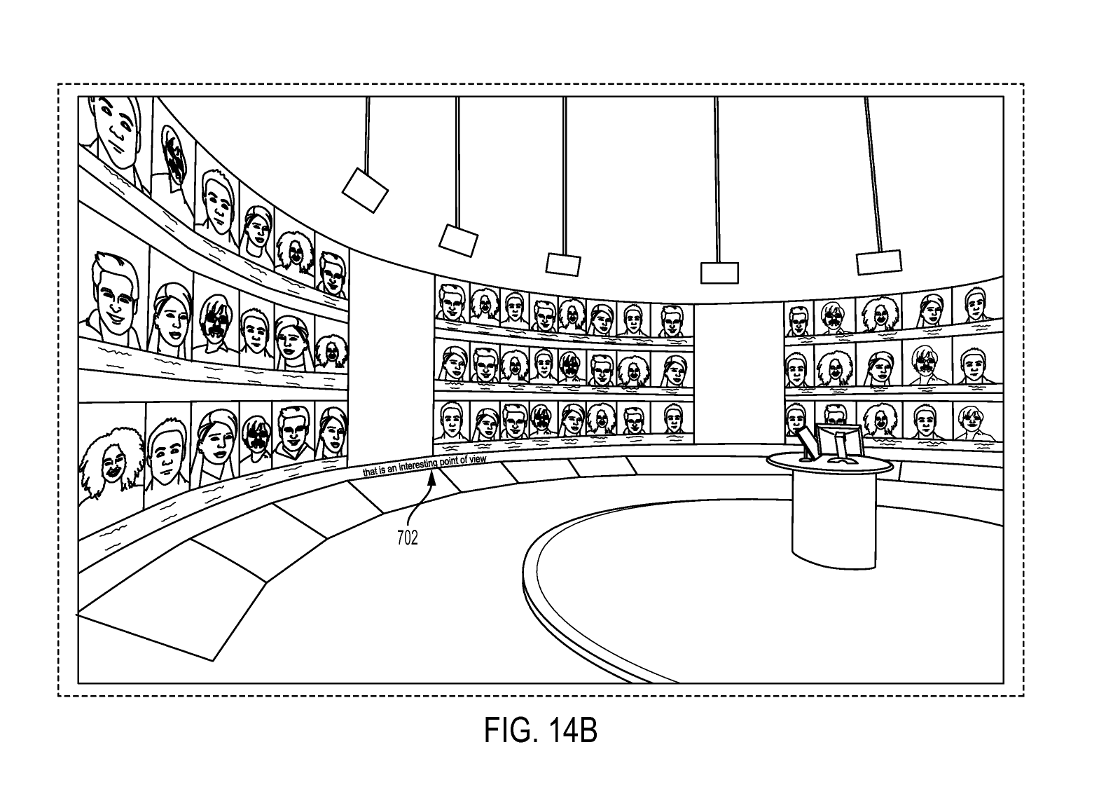

FIG. 14A is a screenshot of a student's computer depicting a chat feature, according to some embodiments of the present invention. FIG. 14B is a perspective view of the classroom depicting a ticker, according to some embodiments of the present invention. Referring to them together, the figures show a chat feature 828, a classmate window 1402, and a ticker 702.

As discussed above, another element available on the platform is chat 828. Chat 828 allows members of the class to send messages to one another or to a general message board. Chat 828 promotes the social element found in a non-virtual classroom environment.

When a student selects the chat feature 828, a classmate window 1402 appears. The classmate window 1402 shows the other members of the class. The student can select a student from the classmate window and send a chat. In some embodiments, the chat will appear in the ticker 702.

The chat feature promotes engagement in the classroom by allowing students to discuss the lecture or lecture related topics during class. As the student chats can also be displayed on the student video wall, an instructor can see when an inappropriate chat is posted by a student and call the student out. As designed in some embodiments, chats promote engagement with class related activity while disincentivizing random chatter.

Students can also post comments on other student's comments. In some embodiments, a student can comment another student's comment with a free response (e.g., I agree, I disagree, hmmm I'm not sure) or a rating (e.g., star, numerical value, thumbs up). A student can see the ratings in real time or receive an average rating of his or her comments at the end of the course.

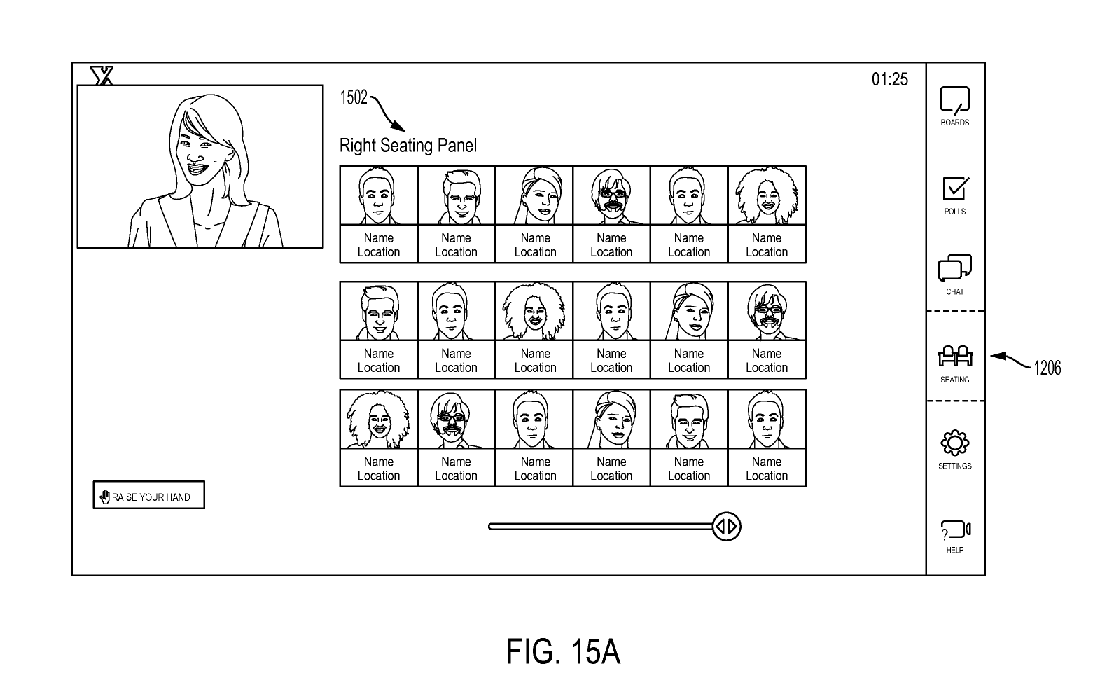

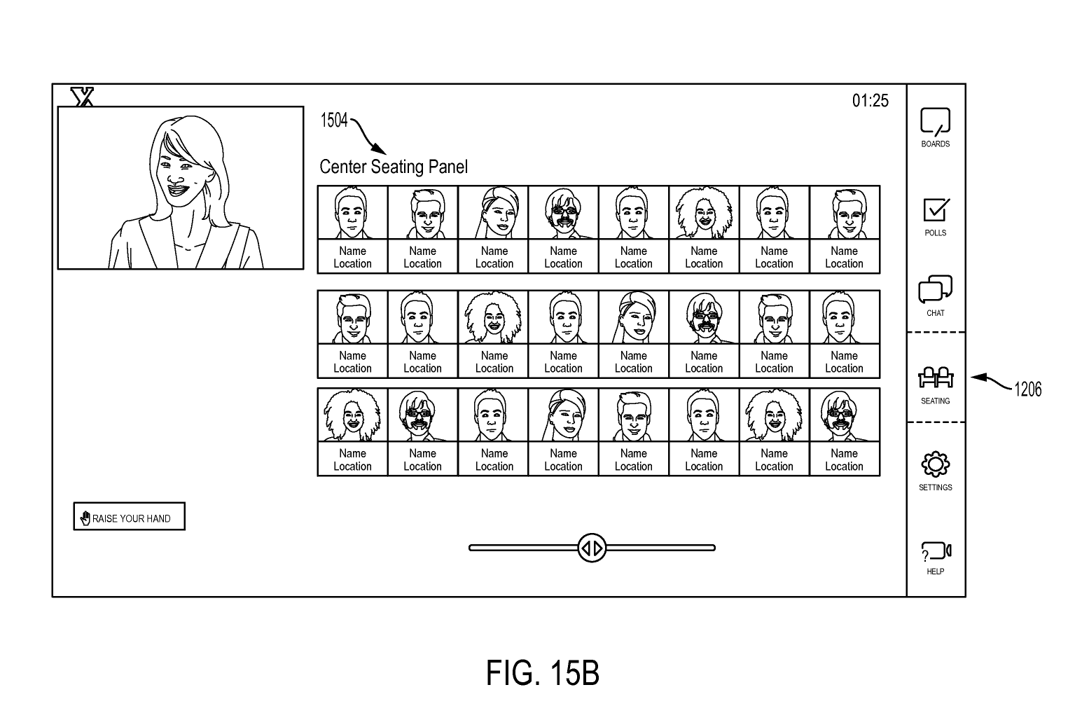

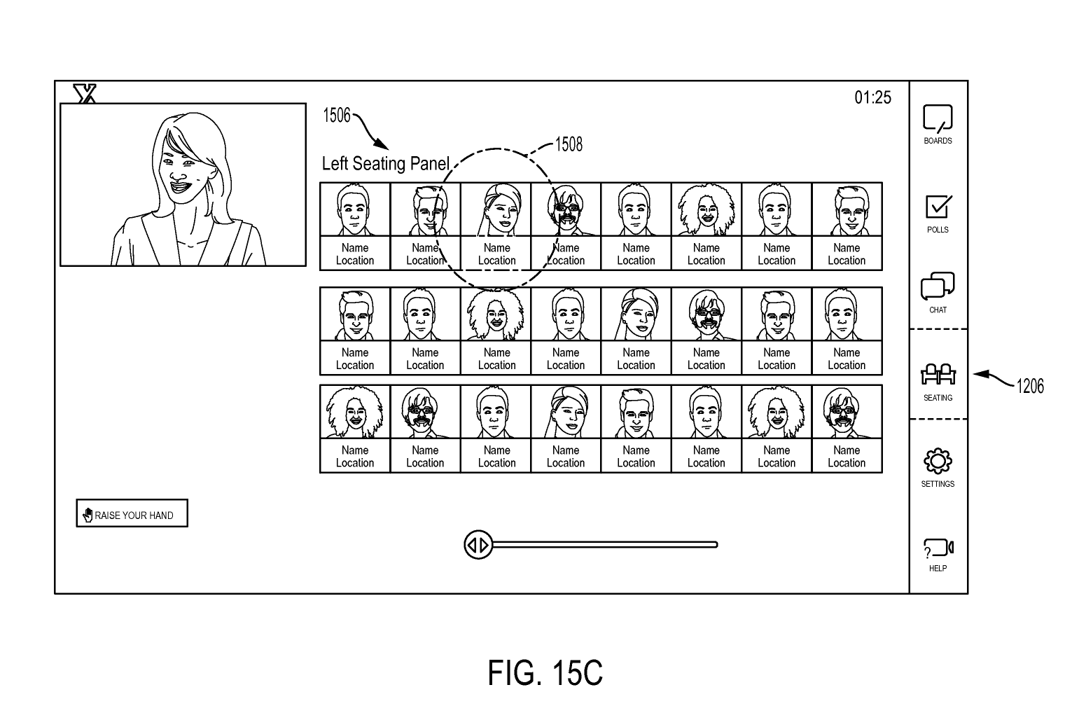

FIG. 15A is a screenshot of a student's computer depicting a right panel seating chart, according to some embodiments of the present invention. FIG. 15B is a screenshot of a student's computer depicting a middle panel seating chart, according to some embodiments of the present invention. FIG. 15C is a screenshot of a student's computer depicting a left panel seating chart, according to some embodiments of the present invention. Referring to them together, the figures show the seating chart feature 1206, a right section seating chart 1502, a center section seating chart 1504, a left section seating chart 1506, and the student corresponding to the user interface (UI) 1508.

As mentioned above, another element available on the platform is a seating chart 1206. The seating chart 1206 is another social element built into the platform. The seating chart serves a functional purpose by providing a map of where other students sit in the classroom. The three sections 1502 1504 1506 show names and images of other students, as well as their place on the student video wall. The UI allows for the student user to scroll through all three sections.

The seating chart also provides a social element by linking to each student's name a picture and profile information. In some embodiments, clicking on a student's name or profile picture results in a pop-up window displaying more information about each student (e.g., location, favorite color, previous occupation). Having this information can help a student decide their social network for the class. For example, an older student with a family may want to join a study group with other older students in a similar situation. A student with little finance experience may want to join a group with those more experienced in finance. A student may be a sports fan and want to join a group with those who like baseball. As in a classroom, having profile information allows a student to get to know the other students in a class, and to pick those they would feel more comfortable studying with in a group.

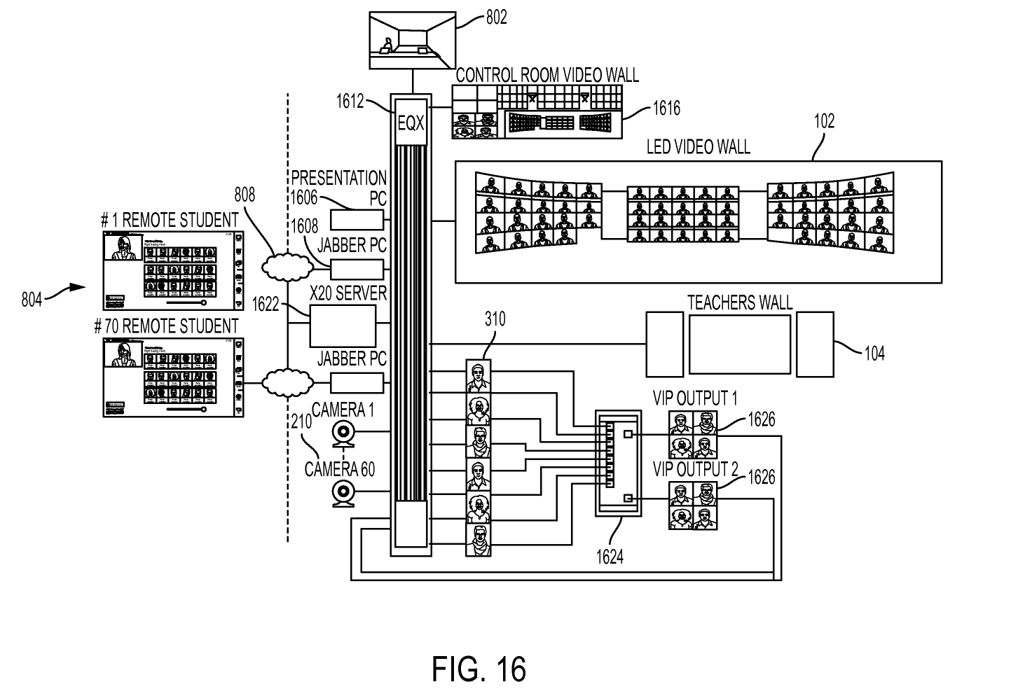

FIG. 16 is a system architecture diagram depicting a case-study approach telepresence system, according to some embodiments of the present invention. It shows a student platform 804, internet connection 808, a presentation PC 1606, a Jabber PC 1608, a camera 210, a video/audio router 1612, a control room 802, a control room video wall 1616, a student video wall 102, a teaching wall 104, remote location student video feeds 310, X2O server 1622, Video and Imaging Processing Module (VIP) 1624, and VIP output 1626.

A student platform 804 is connected to a video/audio router 1612 (e.g., Evertz EQX) through an internet connection 808 and a Jabber PC 1608. In some embodiments, the student platform 804 can reside within a browser (e.g., Chrome, Internet Explorer, Firefox, Safari) on a computing device (e.g., desktop, laptop, tablet). An image capturing device (e.g., external camera, built-in camera) can also be operatively connected to the computing device. The image capturing device can capture an image of the user and the computing device can send the image to the router 1612. Text entered by the user (e.g., chat, question, answer to a poll) can be received by the Jabber PC 1608 and relayed to the router 1622 or directed to other students through the X2O server 1622.

Jabber is a video client that is being run on the Jabber PC 1608. X2O web platform runs on an X2O server 1622. The X2O web platform is a mechanism that allows the student to interact with chat, text, hand raise, etc. The student can input a chat message on the web interface 804. The chat message can be received by an X2O server 1622 and then sent to the house video routing system 1612. Based on design, the chat appears in some areas, such as the ticker wall, with no intervention from the control room 802. The same applies to the hand raise and polling features. In a way, these components are automated to display in certain ways and in certain areas of the system. The Jabber video client is embedded in the X2O platform and runs on both the local 1608 and student PC 804 as a plug-in. In this classroom model, the web platform is the central tool for delivering the case study telepresence approach classroom. Audio (e.g., student speaking, background noise) is also received by the computing device and sent to the router 1612. In embodiments where students have adjustable perspective views, student perspective view controls (e.g., pan and tilt) are also received by the computing device and sent to the router 1612.

A presentation PC 1606 can be a laptop or desktop model and is used by the instructor to show content (i.e. power point slides, excel spread sheets or video clips among other types of content). The PC 1606 is connected to the system through the audio and video routing system and is presented to the students as a source. When directed by the instructor, the control room 802 can select the PC 1606 and send this source to the students' PC 804 much as they would send a video camera source. An instructor can use the presentation PC 1606 to call up features in real time.

A camera 210 captures a perspective view for each of the student images 112 on the student video wall 102. The camera feed is also sent to the video/audio router 1612.

The teaching wall 104 is also fed into the video/audio router 1612. In some embodiments, each of the blackboards on the teaching wall is fed into the router 1612 as a separate feed.

In addition to receiving blackboard feeds, the router 1612 also receives inputs from an instructor's microphone. In some embodiments, the microphone is worn by the instructor. In some embodiments, the microphone filters out background noise and picks up mostly the instructor's voice.

The student video wall 102 receives a video feed from the router 1612 including an image feed of each student in the classroom. The remote location student video feeds and associated student information (e.g., location, status) are displayed on the student video wall 102. In some embodiments, the student video wall 102 comprises an LED video wall. An LED video wall allows for images to be displayed in a variety of ways. For example, instead of having 60 individual students on the wall, the LED wall can display one giant image or several small images. An LED wall produces less heat and requires less cooling equipment generally than other display sources. The LED wall can also eliminate the need to have bezels in between each of the student images 112.

The student video wall 102 also receives an audio feed from each student via the router 1612. As described above, each student image 112 can have its own speaker. The speakers can output any sounds made by the students throughout the duration of the course (e.g., laughter, coughing, comments). Each speaker can act as a point source such that an instructor can determine which student made a particular noise. For example, the instructor can determine when a student on the right hand side of the telepresence classroom laughs at a joke. A unique student audio feed can also be sent out to the students. The student audio feed comprises a mix of all sources (e.g., instructor, other students and content sources) minus a student's own audio. The audio feeds can require high levels of audio signal processing. In some embodiments, if the audio is not mixed as described above, each student can hear themselves and begin to create feedback that would make communication difficult.

The student video wall 102 can also display blackboard images from the teaching wall 104 and student chats via the router 1612.

The control room 802 decides what inputs from the router are displayed on the video wall and on individual student platforms. The control room includes a control room video wall 1616. The control room video wall 1616 can display any video or content input source in the system to the technical staff directing the show. The control room has PCs that act as the control interface for video and audio switching. The video control PCs allow the technical staff to route video to the control room monitors, remote student PCs, student video wall, teaching wall and displays on the teaching podium. The audio control PC allows the technical staff to route audio signals throughout the system and mute or unmute any incoming or outgoing audio signal. These audio signals may include microphones, content audio sources, or incoming student audio. The control room contains additional control PCs to allow technical staff to mimic the same control the teaching podium has, build class rosters and launch classes. In addition, these PCs allow technical support staff to assist students when they experience technical difficulties during class or at other times outside the actual class time. Through the displays, control PCs and technical staff the control room becomes the central hub required to create the case study telepresence approach classroom.

The VIP 1624 receives video and audio streams from the router 1612. Among the video streams received include remote location student video feeds 310. The VIP 1624 combines video and audio streams designated by the control room 802 to produce VIP outputs 1626. The VIP outputs 1626 are fed back into the router for display in the control room video wall 1616 or on student platforms. As discussed above, the router sends to each student a unique audio feed including all audio feeds from the course (e.g., feeds from the teacher's microphones, and feeds from other student's microphones) minus the student's remote location student audio feed 310. The router also sends to each student video feeds including both unique and universal feeds. Each student receives a unique remote location student video feed 310 and a student perspective view 820. All other course content feeds sent to the students are selected by the control room and combined by the VIP into a single feed, which is sent by the router as an identical feed for each student. For example, in debate mode, each student will receive an identical video feed including remote location student video feeds 310 of the debate participants. The remote location student video feeds 310 of the debate participants are combined by the VIP into one stream before the router sends the feed to the students. Combining several feeds into one feed to send out to all students allows for multiple feeds to be represented for a particular screen resolution (e.g., 1366×768). Examples of different layouts that can be displayed are a full screen view of a student and or an instructor, a two screen view of an instructor and a student, a four screen view of an instructor and three students, and a side bar view of an instruction in a larger video window with up to three students in smaller video windows. The combined video feed can be displayed in one section of a student's platform. Each student can also receive a unique remote location student video feed 310 and a student perspective view 820 corresponding to the student in a separate section of the user platform. In some embodiments, the router also sends a drama camera view as part of the identical feed sent to each student. In cases where the drama camera view is sent, a student perspective view 820 may not be sent to the student. For example, the control room can select a drama camera view to send to students when the control room wants to highlight a teacher's movements up close or when the teacher moves somewhere in the pit that is at the edge of a field of view for some students.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A telepresence system for mimicking a physical amphitheater classroom for a case-study course with remote students, the system comprising:
a student wall approximately 9 to 15 feet in height shaped and arranged to define an amphitheater in an arc of about 90 to 210 degrees with a diameter generally between 27 to 32 feet in diameter, an interior of the arc defining a teaching pit where the instructor can move within, the student wall including:
a video display apparatus to present an array of images arranged in groups, mimicking seating assignments in an amphitheater, the images generally rectangular with one side approximately 2 feet long and another side approximately 2.5 feet long, wherein each image is associated to a corresponding student participating in the course and the images are generally in a fixed seating arrangement during the course;
a plurality of student speakers, each of the plurality of student speakers associated with and positioned near a corresponding student image, the plurality of student speakers outputting sound received from a corresponding live microphone such that any and all sound made by each student will be output as a point source of audio such that the instructor can associate and distinguish a sound with a student image from a position from which the sound originates; and
a plurality of student perspective cameras, each of the plurality of student perspective cameras associated with and located near a corresponding student image for capturing a unique perspective view of the telepresence classroom for each student based on the location of a student image on the student wall, a portion of the student perspective cameras oriented such that each camera's field of view captures at least a portion of the student wall and the other student images,
wherein the dimensions of the student wall and of the images in relation to the teaching pit have a geometric relationship such that from the instructor's perspective the student images are approximately life-sized and the instructor can move anywhere within the pit and maintain a line of sight with the perspective student cameras, mimicking a physical amphitheater classroom for a case-study course with remote students.

2. The telepresence system of claim 1, wherein the video display apparatus includes a computer controlled single screen, in which computer controls segment the screen into a plurality of student images.

3. The telepresence system of claim 1, wherein the video display apparatus further presents at least one multimedia display area for displaying at least one of annotations made by an instructor on an electronic blackboard during class, a presentation, poll results, and student chats.

4. The telepresence system of claim 3, wherein the multimedia display area comprises a ticker displaying student chats in real time.

5. The telepresence system of claim 3, wherein the multimedia display area comprises at least one divider positioned between the array of images such that the array of images are divided into smaller groups of images.

6. The telepresence system of claim 1, wherein a longer side of the image corresponds to a height of the image and a shorter side of the image corresponds to a width of the image.

7. A method for mimicking a physical amphitheater classroom for a case-study course with remote students, the method comprising:
displaying, on a video display apparatus positioned on a student wall, an array of images arranged in groups, mimicking seating assignments in an amphitheater, the images generally rectangular with one side approximately 2 feet long and another side approximately 2.5 feet long, wherein each image is associated to a corresponding student participating in the course and the images are generally in a fixed seating arrangement during the course, the student wall approximately 9 to 15 feet in height shaped and arranged to define an amphitheater in an arc of about 90 to 210 degrees with a diameter generally between 27 to 32 feet in diameter, an interior of the arc defining a teaching pit where the instructor can move within;
outputting, from a plurality of student speakers positioned on the student wall, each of the plurality of student speakers associated with and positioned near a corresponding student image, sound received from a corresponding live microphone such that any and all sound made by each student will be output as a point source of audio such that the instructor can associate and distinguish a sound with a student image from a position from which the sound originates; and
receiving, from a portion of a plurality of student perspective cameras positioned on the student wall, each of the plurality of student perspective cameras associated with and located near a corresponding student image for capturing a unique perspective view of the telepresence classroom for each student based on the location of a student image on the student wall, a video signal corresponding to an orientation of the plurality of student perspective cameras such that each camera's field of view captures at least a portion of the student wall and the other student images,
wherein the dimensions of the student wall and of the images in relation to the teaching pit have a geometric relationship such that from the instructor's perspective the student images are approximately life-sized and the instructor can move anywhere within the pit and maintain a line of sight with the perspective student cameras, mimicking a physical amphitheater classroom for a case-study course with remote students.

8. The method of claim 7, wherein the video display apparatus includes a computer controlled single screen, in which computer controls segment the screen into a plurality of student images.

9. The method of claim 7, wherein the video display apparatus further presents at least one multimedia display area for displaying at least one of annotations made by an instructor on an electronic blackboard during class, a presentation, poll results, and student chats.

10. The method of claim 9, wherein the multimedia display area comprises a ticker displaying student chats in real time.

11. The method of claim 9, wherein the multimedia display area comprises at least one divider positioned between the array of images such that the array of images are divided into smaller groups of images.

12. The method of claim 7, wherein a longer side of the image corresponds to a height of the image and a shorter side of the image corresponds to a width of the image.

13. A telepresence system for mimicking a student experience in a physical amphitheater classroom for a case-study course with remote students, the system comprising:
a student wall shaped and arranged to define an amphitheater in an arc, an interior of the arc defining a teaching pit where the instructor can move within, the student wall including:
a video display apparatus to present an array of images arranged in groups, mimicking seating assignments in an amphitheater, wherein each image is associated to a corresponding student participating in the course and the images are generally in a fixed seating arrangement during the course; and
a plurality of student perspective cameras, each of the plurality of student perspective cameras associated with and located near a corresponding student image for capturing a unique studio signal perspective view of the telepresence classroom for each student based on the location of the student image on the student wall, a portion of the student perspective cameras oriented such that its field of view captures at least a portion of the student wall and the other student images, the dimensions of the wall and of the images in relation to the teaching pit have a geometric relationship such that the instructor can move anywhere within the pit and maintain a line of sight with the perspective student cameras;
at least one drama camera, the at least one drama camera configured to have a field of view of the teaching pit separate from the perspective views;
a receiver configured to receive a plurality of course-related multimedia including:
a plurality of unique studio signal perspective views, each of the plurality of unique studio signal perspective views corresponding to a field of view captured by a student perspective camera associated with and located near a corresponding student image,
a plurality of remote location student video signals, each of the remote location student video signals corresponding to a video signal received from a live camera associated with and located near a remote student location,
a plurality of remote location student audio signals, each of the remote location student audio signals corresponding to an audio signal received from a live microphone associated with and located near a remote student location,
an instructor audio signal, the instructor audio signal received from an instructor microphone, and
at least one drama camera video signal, the at least one drama camera video signal corresponding to the field of view captured by the at least one drama camera; and
a dynamically controlled router for forming and transmitting a plurality of audio and video signals to the plurality of remote student locations,
wherein each audio signal transmitted to each remote student location includes a unique student aggregate audio signal formed by aggregating an instructor audio signal and all remote location student audio signals minus the remote location student audio signal corresponding to the student where the unique student aggregate audio signal is transmitted to reflect the sounds of the classroom, and
wherein the plurality of video signals are dynamically selected point-to-point video signals such that each student may have a unique video presentation including a unique studio signal perspective view, the unique studio signal perspective view corresponding to a field of view captured by a student perspective camera associated with and located near a corresponding student image, mimicking a student experience in a physical amphitheater classroom for a case-study course with remote students.

14. The telepresence system of claim 13, wherein the dynamically controlled router responds to operator control commands by a control room operator who monitors events in the course and selects a subset of video feeds to form the point-to-point video presentation to send to each student.

15. The telepresence system of claim 13, wherein the course-related multimedia further includes multimedia answers responsive to an instructor query or question received from one or more students.

16. The telepresence system of claim 13, wherein the course-related multimedia further include annotations made during the course by the instructor on an electronic blackboard.

17. The telepresence system of claim 13, wherein the dynamically selected point-to-point video signals include a plurality of remote location student video signals enabling a debate mode such that students can focus on a discussion between a small group of students and the instructor.

18. The telepresence system of claim 13, wherein the dynamically selected point-to-point video signals include at least one drama camera signal, the drama camera signal including at least one of a close up view of the teacher, a view of the entire teaching wall, and an overhead view of the classroom.

19. The telepresence system of claim 13, wherein the video display apparatus includes a computer controlled single screen, in which computer controls segment the screen into a plurality of student images.

20. The telepresence system of claim 13, wherein the video display apparatus further presents at least one multimedia display area for displaying at least one of annotations made by an instructor on an electronic blackboard during class, a presentation, poll results, and student chats.

21. The telepresence system of claim 20, wherein the multimedia display area comprises a ticker displaying student chats in real time.

22. The telepresence system of claim 20, wherein the multimedia display area comprises at least one divider positioned between the array of images such that the array of images are divided into smaller groups of images.

23. The telepresence system of claim 13, wherein each unique studio signal perspective view is adjustable and the receiver is further configured to receive student perspective view controls from each student corresponding to a pan and tilt of each student perspective camera with respect to a starting position.

24. A method for mimicking a student experience in a physical amphitheater classroom for a case-study course with remote students, the method comprising:
displaying, on a video display apparatus positioned on a student wall, an array of images arranged in groups, mimicking seating assignments in an amphitheater, the images generally in a fixed seating arrangement during the course, the student wall approximately 9 to 15 feet in height shaped and arranged to define an amphitheater in an arc of about 90 to 210 degrees with a diameter generally between 27 to 32 feet in diameter, an interior of the arc defining a teaching pit where the instructor can move within;
receiving, from a portion of a plurality of student perspective cameras positioned on the student wall, a plurality of unique studio signal perspective views corresponding to an orientation of the plurality of student perspective cameras such that each camera's field of view captures at least a portion of the student wall and the other student images, each of the plurality of student perspective cameras associated with and located near a corresponding student image for capturing a unique perspective view of the telepresence classroom for each student based on the location of a student image on the student wall, wherein the dimensions of the student wall and of the images in relation to the teaching pit have a geometric relationship such that the instructor can move anywhere within the pit and maintain a line of sight with the perspective student cameras;
receiving, from a receiver, a plurality of course-related multimedia including:
a plurality of unique studio signal perspective views, each of the plurality of unique studio signal perspective views corresponding to a field of view captured by a student perspective camera associated with and located near a corresponding student image,
a plurality of remote location student video signals, each of the remote location student video signals corresponding to a video signal received from a live camera associated with and located near a remote student location,
a plurality of remote location student audio signals, each of the remote location student audio signals corresponding to an audio signal received from a live microphone associated with and located near a remote student location,
an instructor audio signal, the instructor audio signal received from an instructor microphone, and
at least one drama camera video signal, the at least one drama camera video signal corresponding to the field of view captured by the at least one drama camera; and
forming and transmitting, from a dynamically controlled router, a plurality of audio and video output signals to the plurality of remote student locations,
wherein each audio signal transmitted to each remote student location includes a unique student aggregate audio signal formed by aggregating an instructor audio signal and all remote location student audio signals minus the remote location student audio signal corresponding to the student where the unique student aggregate audio signal is transmitted to reflect the sounds of the classroom, and
wherein the plurality of video signals are dynamically selected point-to-point video signals such that each student may have a unique video presentation including a unique studio signal perspective view, the unique studio signal perspective view corresponding to a field of view captured by a student perspective camera associated with and located near a corresponding student image, mimicking a student experience in a physical amphitheater classroom for a case-study course with remote students.

25. The method of claim 24, wherein the dynamically controlled router responds to operator control commands by a control room operator who monitors events in the course and selects a subset of video feeds to form the point-to-point video presentation to send to each student.

26. The method of claim 24, wherein the course-related multimedia further includes multimedia answers responsive to an instructor query or question received from one or more students.

27. The method of claim 24, wherein the course-related multimedia further includes annotations made during the course by the instructor on an electronic blackboard.

28. The method of claim 24, wherein the dynamically selected point-to-point video signals include a plurality of remote location student video signals enabling a debate mode such that students can focus on a discussion between a small group of students and the instructor.

29. The method of claim 24, wherein the dynamically selected point-to-point video signals include at least one drama camera signal, the drama camera signal including at least one of a close up view of the teacher, a view of the entire teaching wall, and an overhead view of the classroom.

30. The method of claim 24, wherein the video display apparatus includes a computer controlled single screen, in which computer controls segment the screen into a plurality of student images.

31. The method of claim 24, wherein the video display apparatus further presents at least one multimedia display area for displaying at least one of annotations made by an instructor on an electronic blackboard during class, a presentation, poll results, and student chats.

32. The method of claim 31, wherein the multimedia display area comprises a ticker displaying student chats in real time.

33. The method of claim 31, wherein the multimedia display area comprises at least one divider positioned between the array of images such that the array of images are divided into smaller groups of images.

34. The method of claim 33, wherein each unique studio signal perspective view is adjustable and the receiver is further configured to receive student perspective view controls from each student corresponding to a pan and tilt of each student perspective camera with respect to a starting position.
